(19) United States
(12) Patent Application Publication
(10) Pub. No.: US 2013/0138884 A1
(43) Pub. Date: May 30, 2013

(54) LOAD DISTRIBUTION SYSTEM

(71) Applicant: Shunji KAWAMURA, Los Gatos, CA (US)

(72) Inventor: Shunji KAWAMURA, Los Gatos, CA (US)

(73) Assignee: HITACHI, LTD., Tokyo (JP)

(21) Appl. No.: 13/307,254

(22) Filed: Nov. 30, 2011

(51) Int. Cl. G06F 12/08; G06F 12/00

(52) U.S. Cl. 711/119; 711/148; 711/E12.023

(57) ABSTRACT

Exemplary embodiments of the invention provide load distribution among storage systems using solid state memory (e.g., flash memory) as expanded cache area. In accordance with an aspect of the invention, a system comprises a first storage system and a second storage system. The first storage system changes a mode of operation from a first mode to a second mode based on load of process in the first storage system. The load of process in the first storage system in the first mode is executed by the first storage system. The load of process in the first storage system in the second mode is executed by the first storage system and the second storage system.

### BACKGROUND OF THE INVENTION

The present invention relates generally to storage systems and, more particularly, to load distribution among storage systems using high performance media (e.g., flash memory).

In conventional technology, each storage system is designed according to its peak workload. Recently, virtualization technology such as resource pool is used to accommodate the growth of customers' requirements in usage efficiency and cost reduction. There is a trend for more efficient usage of high performance media such as flash memories. Workload balancing in a storage system for long term trend is one virtualization feature. An example involves automated page-based tiering among media (e.g., flash memory, SAS, SATA). At the same time, it is desirable to accommodate short term change (spike) in workload and improve utilization among the plurality of storage systems. Workload balancing among storage systems is not effective in addressing the issue of sudden or periodical short term spike in workload. One solution involves the use of flash memory as a second cache (write buffer) area in a storage system or an appliance. For a storage system, this approach of adding flash memory is not efficient because the flash memory is not shared among the plurality of storage systems. Furthermore, it is difficult to determine which storage system should receive the added resource (i.e., flash memory as a second cache) and how much resource to add. For an appliance, the flash memory is added to a storage caching appliance between the host and the storage systems. This approach of adding flash memory to the appliance allows shared use of the added flash memory in the storage caching appliance among storage systems but the range is limited by the scale of the appliance. Moreover, the approach is not efficient in the case of low or normal workload (normal state).

### BRIEF SUMMARY OF THE INVENTION

Exemplary embodiments of the invention provide load distribution among storage systems using solid state memory (e.g., flash memory) as expanded cache area. In a system, some appliances have solid state memory second cache feature in the pool. These appliances may be referred to FM (Flash Memory) appliances and they are shared in usage by a plurality of DKCs (Disk Controllers). During normal workload, each DKC processes all I/O inside itself. In case of high workload (e.g., the amount of first DRAM cache dirty data in DKCs become too much) in a DKC, the DKC distributes the load to the appliance. After the high workload quiets down or subsides toward the normal workload, that DKC will stop distributing the load to the appliance. By sharing the FM appliance among a plurality of storage systems, (i) utilization efficiency of high-performance resources is improved (storage systems' timings of high-workload are different); (ii) high-performance resources' capacity utilization efficiency is improved (it is possible to minimize non-user capacity such as RAID parity data or spare disks); and (iii) it becomes easier to design to improve performance (user will just add appliance in the pool).

The load distribution technique of this invention can be used for improving high performance media (flash memory) utilization efficiency, for not only flash memory devices but also any other media, for balancing workload among storage systems, for surging temporal/periodical high workload, for making it easier to design system from performance viewpoint, for making it easier to improve performance of physical storage systems, and for applying high performance to lower performance storage system.

In accordance with an aspect of the present invention, a system comprises a first storage system and a second storage system. The first storage system changes a mode of operation from a first mode to a second mode based on load of process in the first storage system. The load of process in the first storage system in the first mode is executed by the first storage system. The load of process in the first storage system in the second mode is executed by the first storage system and the second storage system.

In some embodiments, the first mode is normal mode and the second mode is high workload mode; the first storage system has a first cache area provided by first storage devices and a second cache area provided by second storage devices having higher performance than the first storage devices; during normal mode of operation, I/O (input/output) access to the first storage system is via the first cache area and not via the second cache area for each storage system; and the first storage system changes from the normal mode to the high workload mode if the first storage system has an amount of first cache dirty data in a first cache area which is higher than a first threshold, and the I/O access to the first storage system is through accessing a second cache area for the first storage system.

In specific embodiments, the mode of operation switches from high workload mode to normal mode for the first storage system if the amount of first cache dirty data in the first cache area rises above the first threshold and then falls below a second threshold. The first cache area is provided by first storage devices in the first storage system and the second cache area is provided by second storage devices in the second storage system.

In some embodiments, the second storage system is an appliance having higher performance resources than resources in the first storage system; the first mode is normal mode and the second mode is high workload mode; during normal mode of operation, I/O (input/output) access to the first storage system is direct and not via the appliance; and the first storage system changes from the normal mode to the high workload mode if the first storage system has an amount of first cache dirty data in a first cache area which is higher than a first threshold, and the I/O access to the first storage system is through accessing the appliance during the high workload mode.

In specific embodiments, the mode of operation switches from high workload mode to normal mode if the amount of first cache dirty data in the first cache area rises above the first threshold and then falls below a second threshold. The first cache area is provided by first storage devices in the first storage system and second storage devices in the appliance. The first cache area is provided by first storage devices in the first storage system, wherein the appliance has a second cache area provided by second storage devices having higher performance than the first storage devices, and wherein in the high workload mode, the I/O access to the first storage system is through accessing the second cache area. The first cache area is provided by a logical volume which is separated between the first storage system and the appliance, the logical volume including chunks provided by the first storage system and the appliance. The first cache area is provided by first storage devices in the first storage system, and wherein the appliance provides high tier permanent area, and wherein in the high workload mode, the I/O access to the first storage system is through accessing the high tier permanent area. The first cache area is provided by a first logical volume which is separated between the first storage system and the appliance and a second logical volume, the first logical volume including chunks provided by the first storage system and the appliance, the second logical volume provided by the appliance.

In accordance with another aspect of the invention, a first storage system comprises a processor; a memory; a plurality of storage devices; and a mode operation module configured to change a mode of operation from a first mode to a second mode based on load of process in the first storage system. The load of process in the first storage system is executed by the first storage system in the first mode. The load of process in the first storage system is executed by the first storage system and a second storage system in the second mode.

In some embodiments, the first mode is normal mode and the second mode is high workload mode; the first storage system has a first cache area provided by first storage devices and a second cache area provided by second storage devices having higher performance than the first storage devices; during normal mode of operation, I/O (input/output) access to the first storage system is via the first cache area and not via the second cache area for each storage system; and the first storage system changes from the normal mode to the high workload mode if the first storage system has an amount of first cache dirty data in a first cache area which is higher than a first threshold, and the I/O access to the first storage system is through accessing a second cache area for the first storage system. The mode of operation switches from high workload mode to normal mode for the first storage system if the amount of first cache dirty data in the first cache area rises above the first threshold and then falls below a second threshold. The first cache area is provided by first storage devices in the first storage system and the second cache area is provided by second storage devices in the second storage system.

Another aspect of this invention is directed to a method of I/O (input/output) in a system which includes a first storage system and a second storage system. The method comprises changing a mode of operation in the first storage system from a first mode to a second mode based on load of process in the first storage system. The load of process in the first storage system in the first mode is executed by the first storage system. The load of process in the first storage system in the second mode is executed by the first storage system and the second storage system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of an information system in which the method and apparatus of the invention may be applied, according to the first embodiment.

FIG. 2 illustrates further details of the physical system configuration of the information system of FIG. 1 according to the first embodiment.

FIG. 3 illustrates an example of a logical configuration of the invention applied to the architecture of FIG. 1 according to the first embodiment.

FIG. 4 illustrates an example of a memory in the storage system of FIG. 2.

FIG. 5a shows an example of a LU and LDEV mapping table.

FIG. 5b shows an example of a LDEV and storage pool mapping table.

FIG. 5c shows an example of a pool chunk and tier mapping table.

FIG. 5d shows an example of a pool-tier information table.

FIG. 5e shows an example of a tier chunk and RAID group mapping table.

FIG. 5f shows an example of a RAID groups information table.

FIG. 5g shows an example of a physical devices (HDDs) information table.

FIG. 5h shows an example of a DRAM information table.

FIG. 5i shows an example of a second cache area information table according to the first embodiment.

FIG. 5j shows an example of an external device information table.

FIG. 6a shows an example of a cache directory management information table.

FIG. 6b shows an example of clean queue LRU (Least Recently Used) management information.

FIG. 7 shows an example of a cache utilization information table according to the first embodiment.

FIG. 8 shows an example of a memory in the FM appliance of FIG. 2.

FIG. 9 shows an example of a memory in the management computer of FIG. 2.

FIG. 10 shows an example of an FM appliances workload information table.

FIG. 11 shows an example of a flow diagram illustrating a process of changing mode according to the first embodiment.

FIG. 12a shows an example of a flow diagram illustrating host read I/O processing during distribution/going back mode according to the first embodiment.

FIG. 12b shows an example of a flow diagram illustrating host write I/O processing during distribution/going back mode according to the first embodiment.

FIG. 13a shows an example of a flow diagram illustrating asynchronous cache transfer from first cache to second cache during distribution mode according to the first embodiment.

FIG. 13b shows an example of a flow diagram illustrating asynchronous data transfer from second cache to first cache during distribution and going back modes according to the first embodiment.

FIG. 14 illustrates an example of a hardware configuration of an information system according to the second embodiment.

FIG. 15 illustrates further details of the physical system configuration of the information system of FIG. 14 according to the second embodiment.

FIG. 16 illustrates an example of a hardware configuration of an information system according to the third embodiment.

FIG. 17 illustrates an example of a hardware configuration of an information system according to the fourth embodiment.

FIG. 18a is a flow diagram illustrating an example of mode transition caused by power unit failure.

FIG. 18b is a flow diagram illustrating an example of mode transition caused by DRAM failure.

FIG. 18c is a flow diagram illustrating an example of mode transition caused by HDD failure.

FIG. 18d is a flow diagram illustrating an example of mode transition caused by CPU failure.

FIG. 19 is a flow diagram illustrating an example of filling the second cache.

FIG. 20 is a flow diagram illustrating an example of allocating the second cache.

FIG. 21 illustrates an example of a logical configuration of the invention according to the second embodiment.

FIG. 22 shows an example of a second cache area information table according to the second embodiment.

FIG. 23 shows an example of a cache utilization information table according to the second embodiment.

FIG. 24 shows an example of a flow diagram illustrating a process of mode transition according to the second embodiment.

FIG. 25 shows an example of a flow diagram illustrating a process of asynchronous cache transfer according to the second embodiment.

FIG. 26 illustrates an example of a logical configuration of the invention according to the third embodiment.

FIG. 27 shows an example of a second cache area information table according to the third embodiment.

FIG. 28 shows an example of a cache utilization information table according to the third embodiment.

FIG. 29a shows an example of a flow diagram illustrating host read I/O processing during distribution/going back mode according to the third embodiment.

FIG. 29b shows an example of a flow diagram illustrating host write I/O processing during distribution/going back mode according to the third embodiment.

FIG. 30 is an example of a flow diagram illustrating a process of asynchronous data transfer from external first cache to permanent area during distribution and going back modes according to the third embodiment.

FIG. 31 illustrates an example of a logical configuration of the invention according to the fourth embodiment.

FIG. 32 shows an example of a flow diagram illustrating a process of mode transition according to the fourth embodiment.

FIG. 33a shows an example of a flow diagram illustrating a process of path switching from normal mode to distribution mode according to the fourth embodiment.

FIG. 33b shows an example of a flow diagram illustrating a process of switching from distribution-mode (going back-mode) to normal-mode according to the fourth embodiment.

FIG. 34a shows an example of a flow diagram illustrating asynchronous cache transfer from first cache to second cache during distribution mode in the FM appliance according to the fourth embodiment.

FIG. 34b shows an example of a flow diagram illustrating host read I/O processing during distribution mode in the FM appliance according to the fourth embodiment.

FIG. 34c shows an example of a process pattern of a host write I/O processing during going back mode in the FM appliance according to the fourth embodiment.

FIG. 35 illustrates an example of a logical configuration of the invention according to the fifth embodiment.

FIG. 36 shows an example of an information table of chunk distributed among several storage systems and FM appliances according to the fifth embodiment.

FIG. 37 shows an example of a flow diagram illustrating host read I/O processing in the case where a chunk is distributed among plural storage systems according to the fifth embodiment.

FIG. 38 illustrates an example of a logical configuration of the invention according to the sixth embodiment.

FIG. 39 shows an example of a flow diagram of the management computer according to the sixth embodiment.

FIG. 40 shows an example of a flow diagram illustrating a process of chunk migration from external FM appliance to internal device in the storage system according to the sixth embodiment.

FIG. 41 shows an example of a flow diagram illustrating a process of chunk migration from internal device in the storage system to external FM appliance according to the sixth embodiment.

FIG. 42 illustrates an example of a logical configuration of the invention according to the seventh embodiment.

FIG. 43 shows an example of a flow diagram illustrating a process of the management computer to distribute workload with volume migration according to the seventh embodiment.

FIG. 44a shows an example of a flow diagram illustrating a process of volume migration from storage system to FM appliance according to the seventh embodiment.

FIG. 44b shows an example of a flow diagram illustrating a process of volume migration from the FM appliance to the storage system according to the seventh embodiment.

FIG. 45a shows an example of an information table of LDEV group and distribution method according to the eighth embodiment.

FIG. 45b shows an example of mapping of LDEV to LDEV group according to the eighth embodiment.

FIG. 46 shows an example of an information table of reservation according to the ninth embodiment.

FIG. 47 illustrates an example of a logical configuration of the invention according to the tenth embodiment.

FIG. 48 shows an example of information of allocation of the FM appliance according to the tenth embodiment.

FIG. 49 shows an example of a flow diagram illustrating a process of allocating and releasing FM appliance area according to the tenth embodiment.

FIG. 50 illustrates a concept of the present invention.

FIG. 51 shows an example of an information table of LDEV in the FM appliance according to the seventh embodiment.

FIG. 52 shows an example of an information table of LDEV chunk in the FM appliance.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for load distribution among storage systems using solid state memory (e.g., flash memory) as expanded cache area.

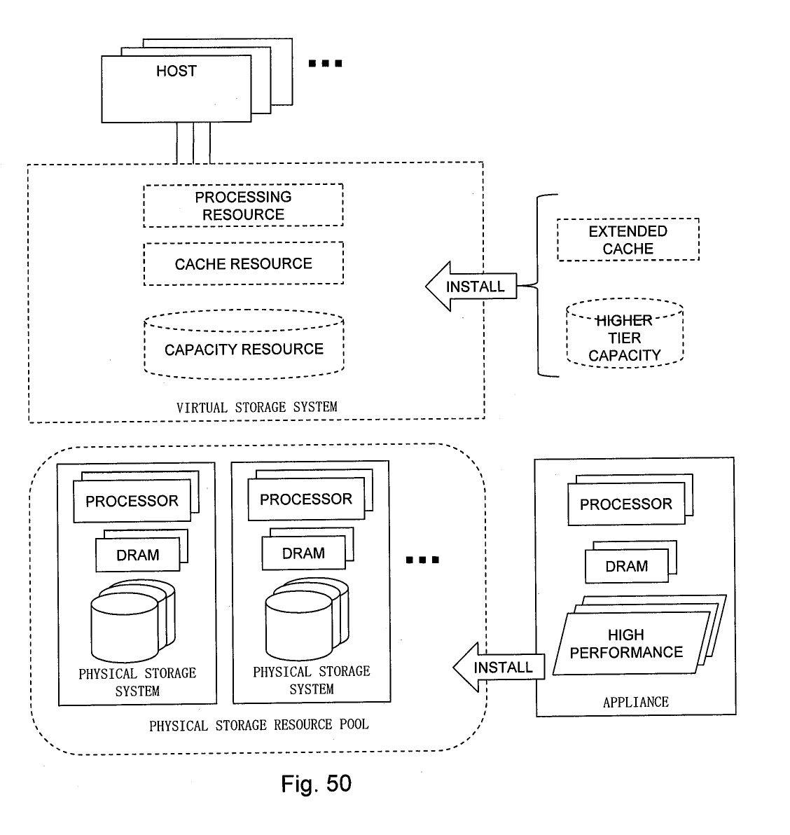

FIG. 50 illustrates a concept of the present invention. A physical storage resource pool consists of one or more physical storage systems. The hosts see the storage systems as one virtual storage system that consists of the storage resource pool (one or more physical storage systems). This means that the hosts do not need to stop and be re-configured by a server manager due to a change in physical storage system configuration, using technologies such as non-disruptive data migration among storage systems. The virtual storage system has likely storage resources such as processing resource, caching resource, and capacity resource. Installing an FM (high performance) appliance to the storage resource pool means installing higher performance resources such as extended (second) cache and higher tier capacity to the virtual storage system. The resources of the appliance are shared in usage among the physical storage systems in the pool. It is possible to improve performance of the virtual storage system (and hence the physical storage systems) by just installing the appliance.

### I. First Embodiment

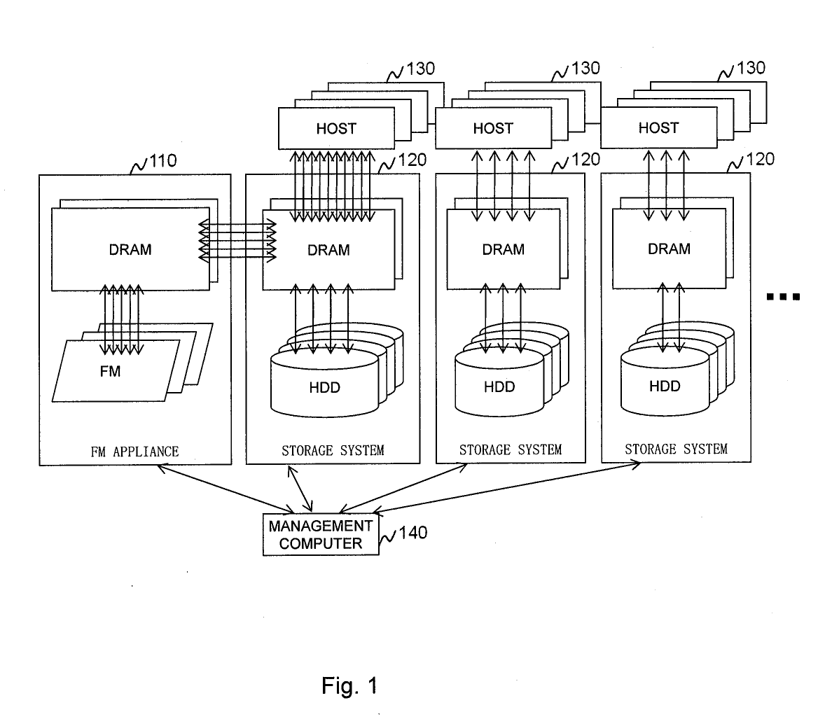

FIG. 1 illustrates an example of a hardware configuration of an information system in which the method and apparatus of the invention may be applied. The information system includes a plurality of storage systems 120 and a FM appliance 110 that has high performance media devices such as flash memory (FM) devices. The appliance 110 is shared in usage by the storage systems 120. A management computer 140 collects and stores the workload information from each storage system 120 and the FM appliance 110. During normal (lower) workload, each storage system 120 processes I/O from hosts 130 inside itself. In case of high workload in a storage system 120 (amount/ratio of DRAM cache dirty data in storage system 120 becomes too much), that storage system 120 distributes the load to the appliance 110. After the high workload quiets down or subsides, the storage system 120 will stop distributing the load to the appliance 110.

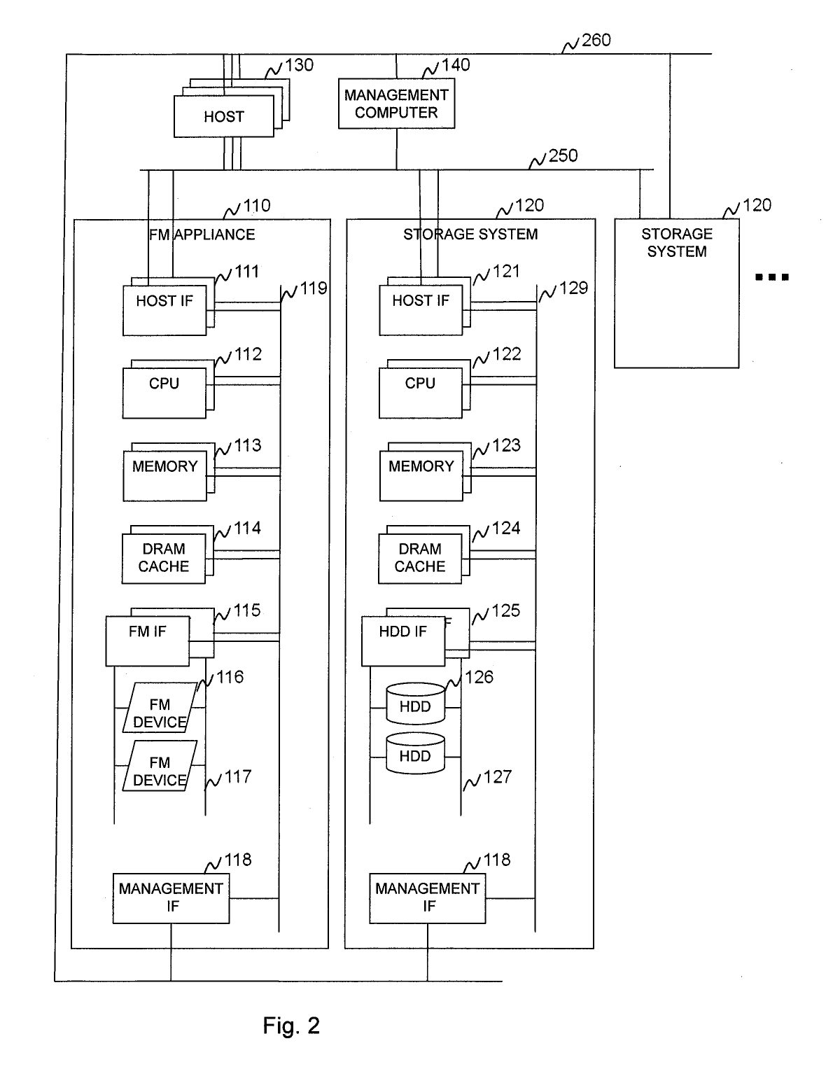

FIG. 2 illustrates further details of the physical system configuration of the information system of FIG. 1. The SAN (Storage Area Network) 250 is used as data transfer network, and the LAN (Local Area Network) 260 is used as management network. The system may include a plurality of FM appliances 110. The host interface 111 in the appliance 110 is also used to transfer data from/to the appliance 110. There can be separate interfaces 111. A memory 113 stores programs and information tables or the like. The appliance 110 further includes a CPU 112, a DRAM cache 114, an FM IF (Interface) 115, FM devices 116, an interface network 117 (may be included in 115), a management IF 118 for interface with the management computer 140, and an internal network 119. The storage system 120 includes a host IF 121 for interface with the host, a CPU 122, a memory 123, a DRAM cache 124, a HDD IF 125, HDDs 126, an interface network 127 (may be included in 125), a management IF 128, and an internal network 129. It is possible that HDDs 126 include several types of hard disk drives, such as FC/SAS/SATA, with different features such as different capacity, different rpm, etc. The management computer 140 also has a network interface, a CPU, and a memory for storing programs and the like.

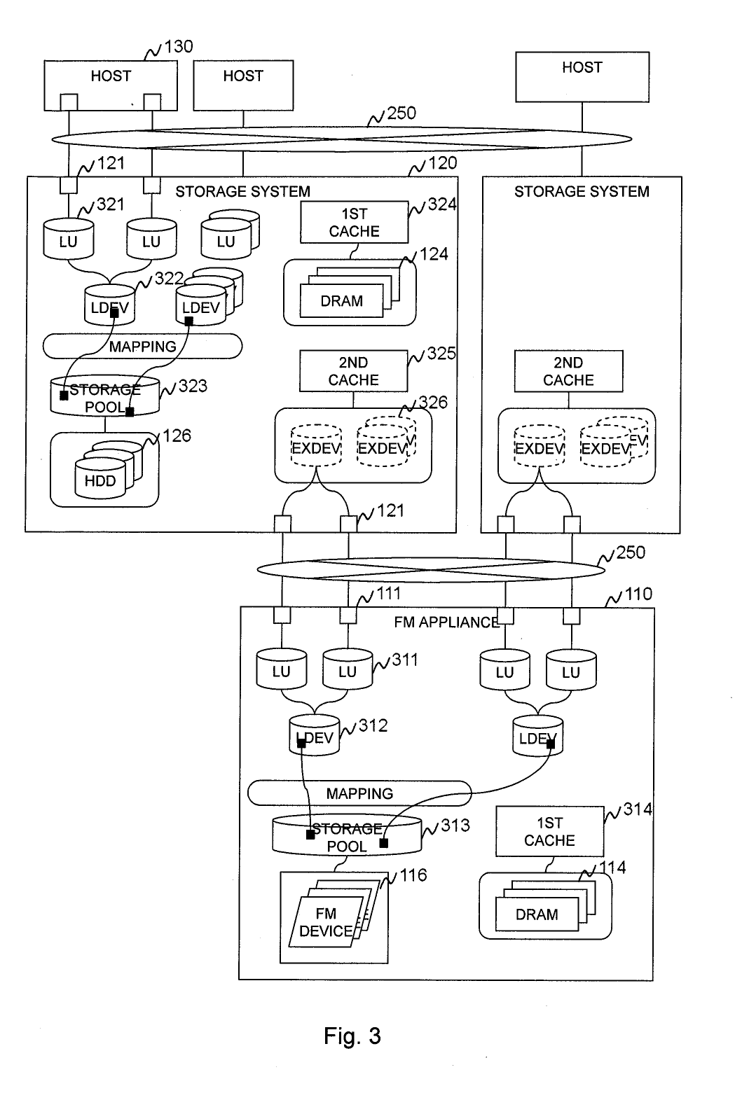

FIG. 3 illustrates an example of a logical configuration of the invention applied to the architecture of FIG. 1. The storage system 120 has logical units (LUs) 321 from volumes (logical devices LDEVs) 322 which are mapped to a storage pool 323 of HDDs 126. The host 130 accesses data in the storage system's volume 322 via the LU 321. The host 130 may connect with multiple paths for redundancy. The data in the LDEVs 322 are mapped to the storage pool (physical storage devices) 323 using technologies such as RAID, page-based-distributed-RAID, thin-provisioning, and dynamic-tiering. The storage pool 323 is used as a permanent storage area (not cache). There can be plural storage pools in one storage system. The storage pool can also include external storage volumes (such as low cost storage). The storage pool data is read/write cached onto a first cache area 324 and a second cache area 325.

The first cache area 324 consists of DRAMs in DRAM cache 124 and the second cache area 325 consists of external devices 326. Each external device 326 is a virtual device that virtualizes a volume (LDEV) 312 of the FM appliance 110. The external device 326 can be connected to the FM appliance 110 with multiple paths for redundancy. The FM appliance 110 includes a storage pool 313 consisting of FM devices 116. The storage pool data is read/write cached onto a first cache area 314 which consists of DRAMs in the DRAM cache 114.

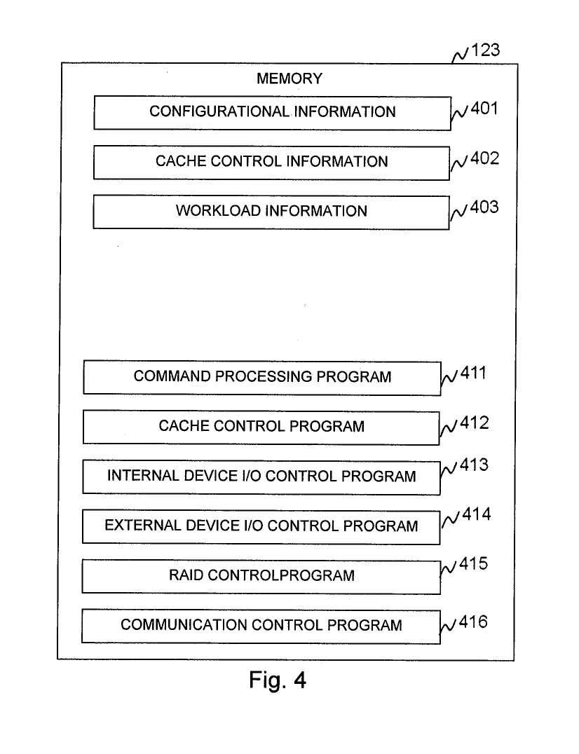

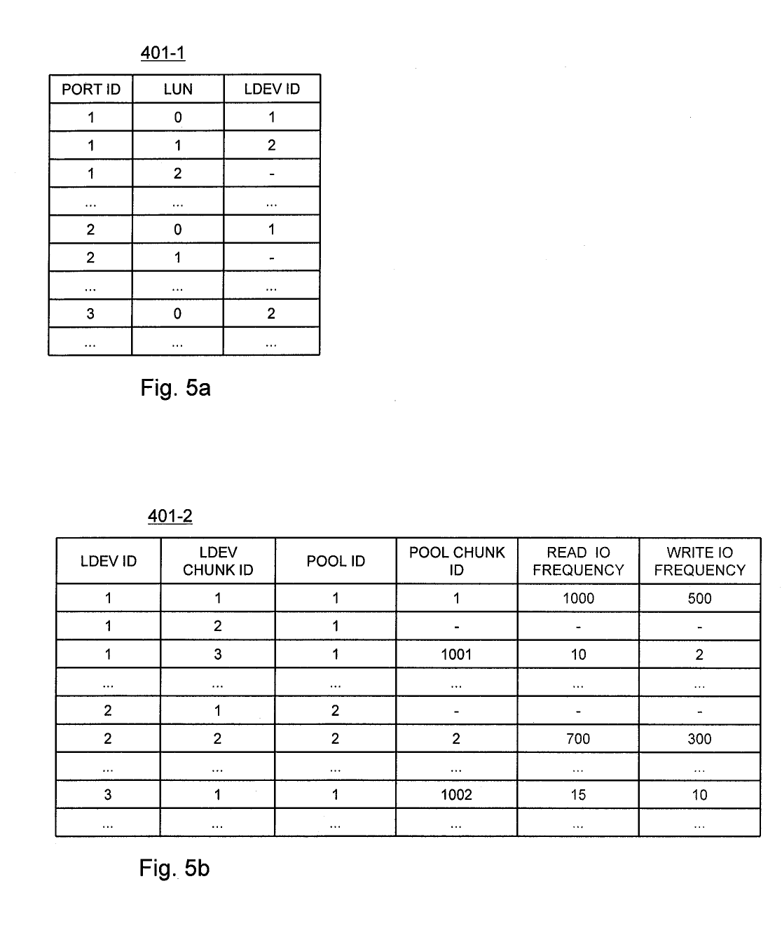

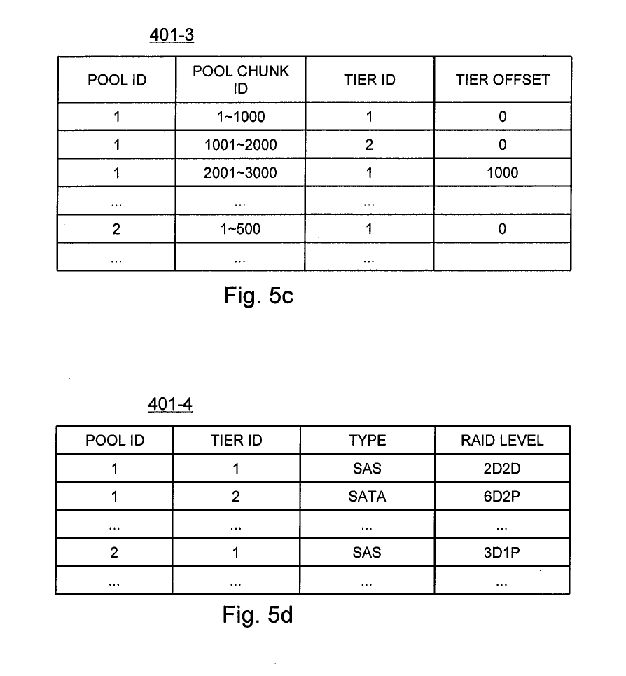

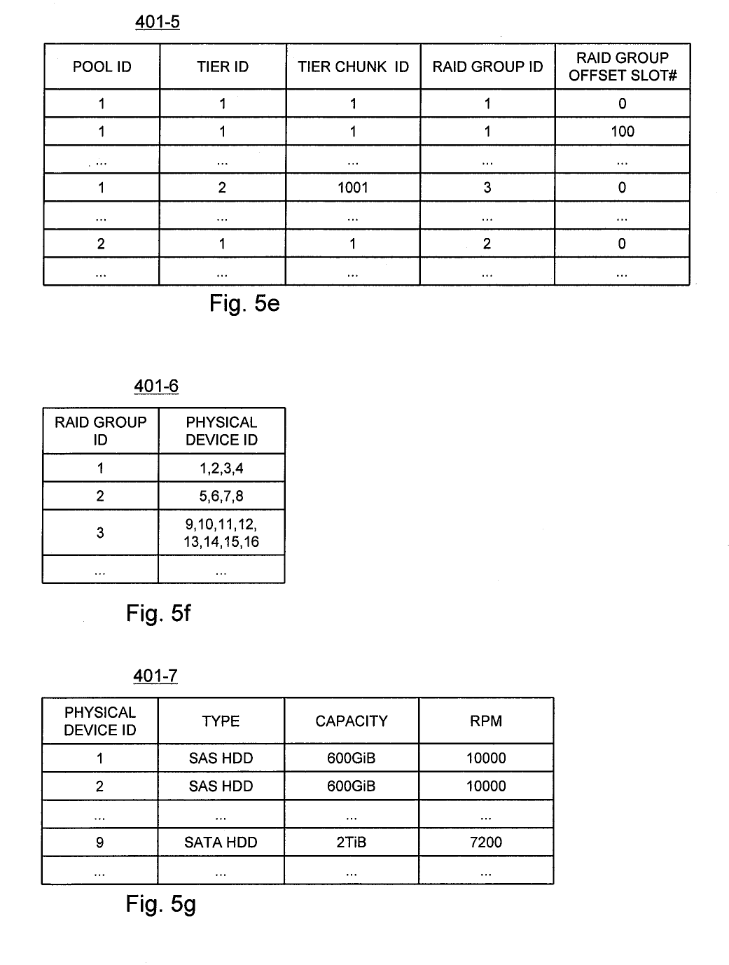

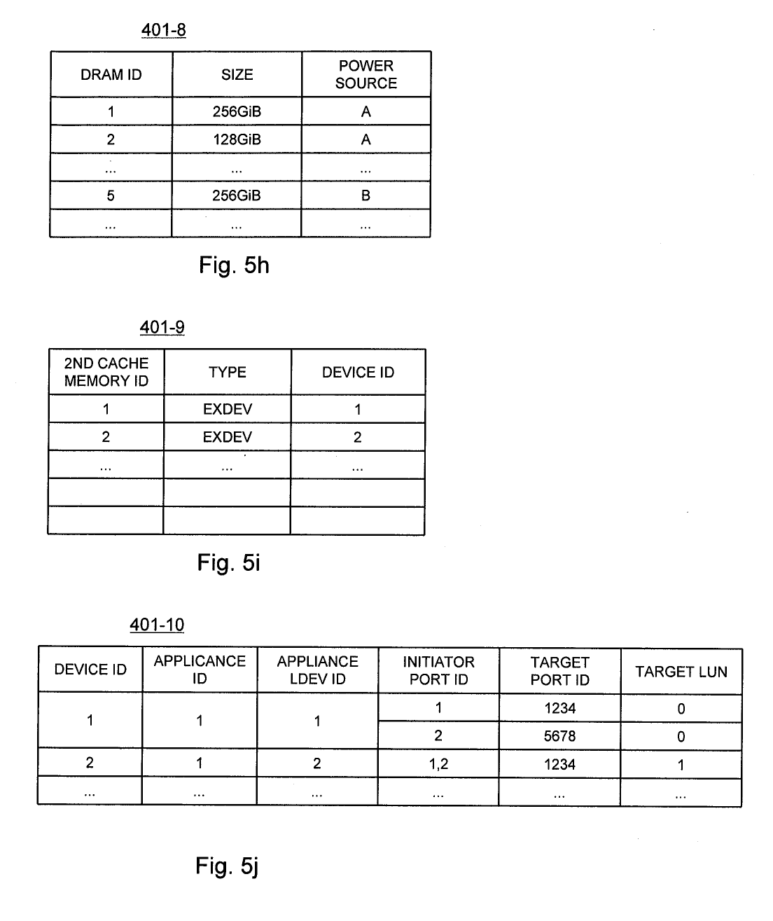

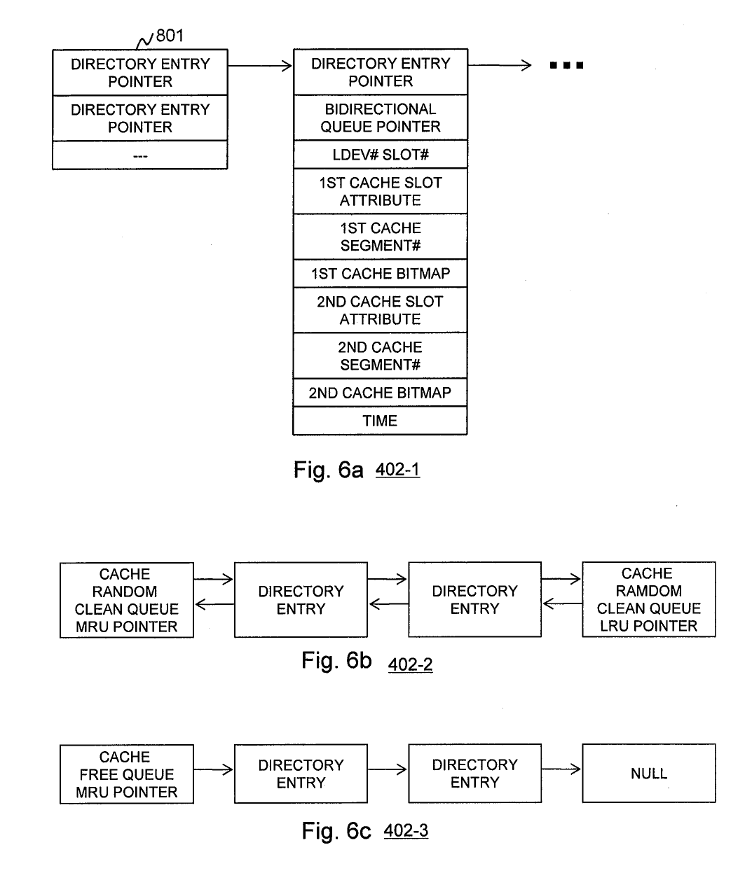

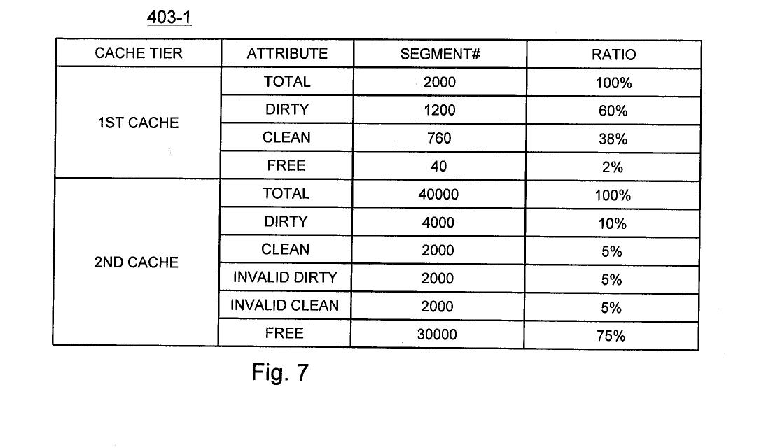

FIG. 4 illustrates an example of a memory 123 in the storage system 120 of FIG. 2. The memory 123 includes configuration information 401 (FIG. 5), cache control information 402 (FIG. 6), and workload information 403 (FIG. 7). The storage system 120 processes the read/write I/O from the host 130 using the command processing program 411, calculates parity or RAID control using the RAID control program 415, performs cache control using cache control program 412, transfers data from/to internal physical devices (HDDs) storage using the internal device I/O control program 413, transfers data from/to external storage systems/FM appliances using the external device I/O control program 414, and exchanges management information/commands among other storage systems, FM appliances, management computer, and hosts using the communication control program 416. The storage system 120 can have other functional programs and their information such as remote copy, local copy, tier migration, and so on.

Various table structures to provide configuration information of the storage system are illustrated in FIG. 5. FIG. 5a shows an example of a LU and LDEV mapping table 401-1 with columns of Port ID, LUN (Logical Unit Number), and LDEV ID. FIG. 5b shows an example of a LDEV and storage pool mapping table 401-2 with columns of LDEV ID, LDEV Chunk ID, Pool ID, and Pool Chunk ID. FIG. 5c shows an example of a pool chunk and tier mapping table 401-3 with columns of Pool ID, Pool Chunk ID, Tier ID, and Tier Offset. FIG. 5d shows an example of a pool-tier information table 401-4 with columns of Pool ID, Tier ID, Type, and RAID Level. FIG. 5e shows an example of a tier chunk and RAID group mapping table 401-5 with columns of Pool ID, Tier ID, Tier Chunk ID, RAID Group ID, and RAID Group Offset Slot#. FIG. 5f shows an example of a RAID groups information table 401-6 with columns of RAID Group ID and Physical Device ID. FIG. 5g shows an example of a physical devices (HDDs) information table 401-7 with columns of Physical Device ID, Type, Capacity, and RPM. FIG. 5h shows an example of a DRAM information table 401-8 with columns of DRAM ID, Size, and Power Source. FIG. 5i shows an example of a second cache area information table 401-9 with columns of Second Cache Memory ID, Type, and Device ID. FIG. 5j shows an example of an external device information table 401-10 with columns of Device ID, Appliance ID, Appliance LDEV ID, Initiator Port ID, Target Port ID, and Target LUN.

Cache control information is presented in FIG. 6. Examples of cache control information can be found in U.S. Pat. No. 7,613,877, which is incorporated herein by reference in its entirety. FIG. 6a shows an example of a cache directory management information table 402-1. The hash table 801 has linked plural pointers that have the same hash value from LDEV#+slot#. The slot# is the address on LDEV (1 slot is 512 Byte×N). A segment is the managed unit of cache area. Each first cache and second cache are managed with the segment. For simplicity, the slot, first cache segment, and second cache segment are the same size in this embodiment. The cache slot attribute is dirty/clean/free. Each first cache and second cache have the cache slot attribute. The segment# is the address on cache area, if the slot is allocated cache area. A cache bitmap shows which block (512 Byte) is stored on the segment. FIG. 6b shows an example of clean queue LRU (Least Recently Used) management information 402-2. The dirty queue and other queues are managed in the same manner. Each first cache and second cache have the queue information. FIG. 6c shows an example of free queue management information 402-3. Each first cache and second cache have the queue information. It is possible to manage free cache area with mapping table (not queued).

FIG. 7 shows an example of a cache utilization information table 403-1 as a type of workload information, with columns of Cache Tier, Attribute, Segment# (amount of segments), and Ratio. This information is used for judging whether to distribute to the FM appliance or not. The second cache segment # segment size is the same as the sum of the external devices' capacities used as the second cache area. The second cache attribute “INVALID CLEAN” and “INVALID DIRTY” means that the second cache area is allocated but the first cache is the newest dirty data. Data on the second cache is old data.

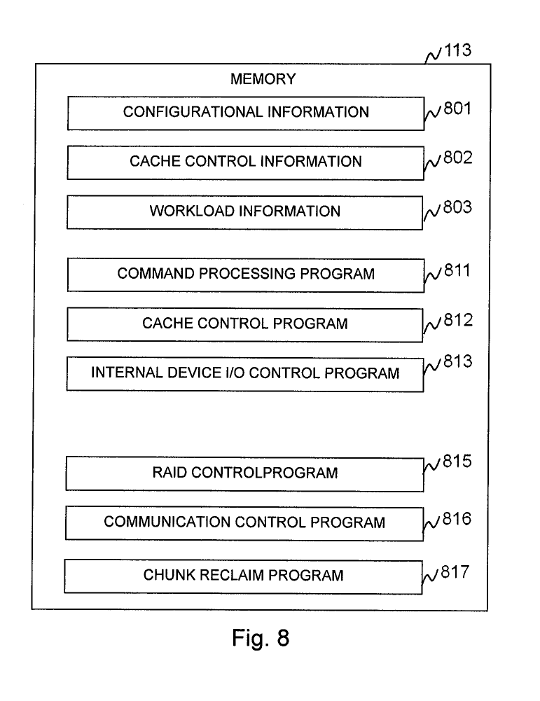

FIG. 8 shows an example of a memory in the FM appliance of FIG. 2. Many of the contents in the memory 113 of the FM appliance 110 are similar to those in the memory 123 of the storage system 120 (801-816 corresponding to 401-416 of FIG. 4). In FIG. 8, the configuration information 801 does not include second cache information and external devices information. The cache control information 802 does not include second cache information. The workload information 803 does not include second cache information. The chunk reclaim program 817 is used to release the second cache area. The storage system sends SCSI write same (0 page reclaim) command to the FM appliance to purge the unused area. The FM appliance makes the released area to free area and can allocate it to other logical device 312.

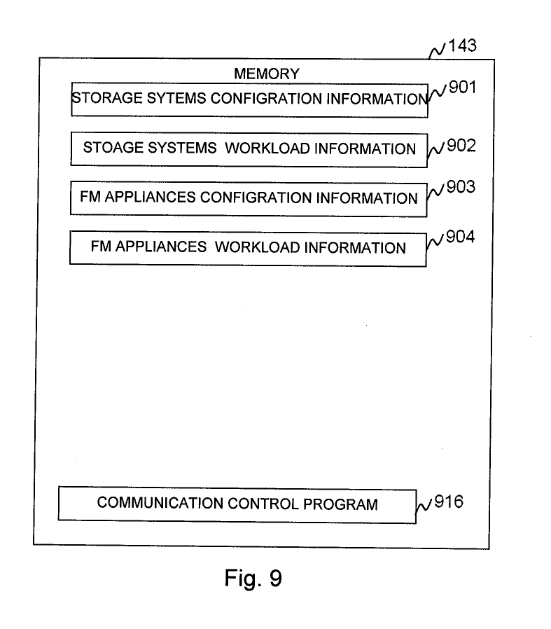

FIG. 9 shows an example of a memory in the management computer of FIG. 2. The contents of the memory 143 of the management computer 140 include storage systems configuration information 901 (see 401 in FIG. 4), storage system workload information 902 (see 403 in FIG. 4), FM appliances configuration information 903 (see 801 in FIG. 8), FM appliance workload information 904 (see 803 in FIG. 8), and communication control program 916. The management computer 140 gets configuration information from each of the storage systems 120 and FM appliances 110 using the communication control program 916.

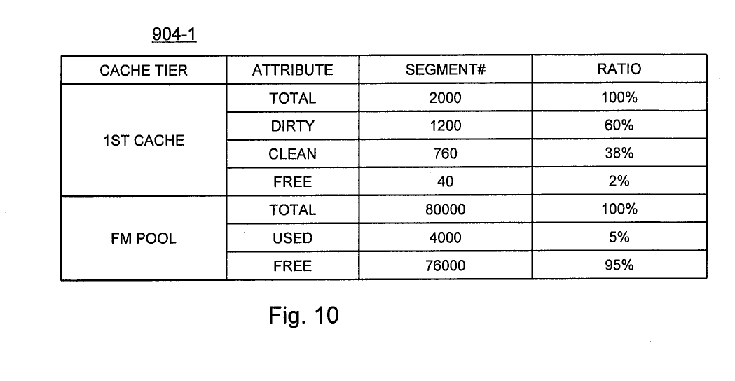

FIG. 10 shows an example of a FM appliances workload information table 904-1 with columns of Cache Tier, Attribute, Segment# (amount of segments), and Ratio. This information is provided per FM appliance 110. The table 904-1 includes information from the cache utilization information table 403-1 of FIG. 7. The table 904-1 also has FM pool utilization information (used/free amount/ratio). It is used to judge whether the FM appliance has enough free FM area to be used as the second cache area by the storage system.

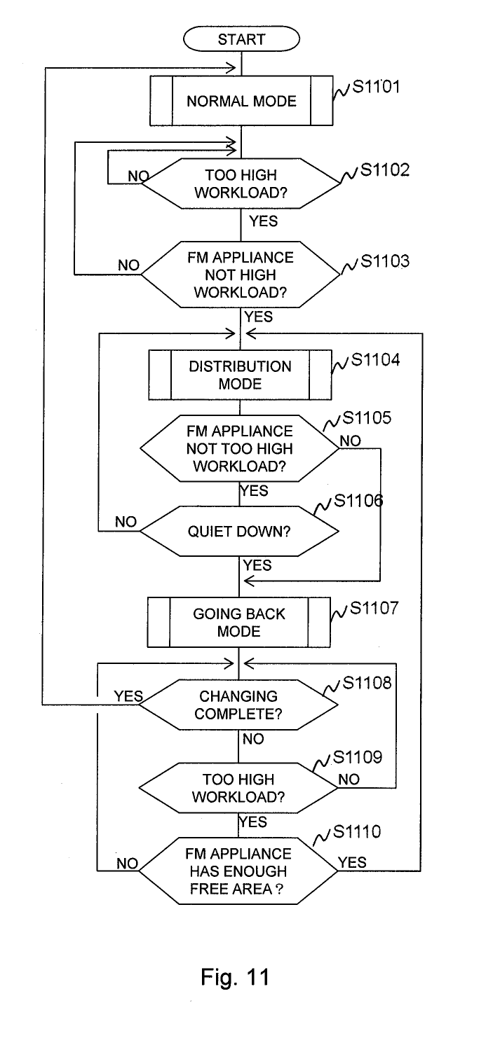

FIG. 11 shows an example of a flow diagram illustrating a process of changing mode. There are three modes of operation. During normal mode (S1101), the storage system uses only internal first cache, and does not use external second cache. If there is too high workload in storage system in S1102, the storage system program proceeds to S1103. If there is not too high workload in FM appliance in S1103, the program proceeds to the distribution mode in S1104. During distribution mode (S1104), the storage system uses not only internal first cache but external second cache. If there is not too high workload in FM appliance in S1105, the program proceeds to S1106; otherwise, the program proceeds to S1107. In S1106, if the workload of the storage system quiets down, the storage system changes to going back mode in S1107; otherwise, the storage system returns to distribution mode S1104. During going back mode (S1107), the storage system uses not only internal first cache but external second cache. However, the storage system does not allocate more second cache, and releases second cache areas that become clean attribute. If the mode changing completes in S1108, the storage system returns to normal mode (S1101). If there is too high workload in the storage system, the program proceeds to S1110; otherwise, the program returns to S1108. If the FM appliance has enough free area, the storage system returns to distribution mode (S1104); otherwise, the program returns to S1108. The mode changes from normal mode (S1101) to distribution mode (S1104) if the storage system determines that the workload is too high (S1102) and the FM appliance is not operating at high workload (S1103). The mode changes from distribution mode (S1104) to going back mode (S1107) (i) if the FM appliance is not operating at too high a workload (S1105), or (ii) if the FM appliance is operating at too high a workload but it has quieted down or subsided (S1106). If the change to the going back mode is complete (S1108), the storage system returns to normal mode (S1101). Otherwise, the mode changes from going back mode (S1107) to distribution mode (S1104) if the workload is still too high (S1109) and the FM appliance has enough free area (S1110).

In FIG. 11, the storage system judges whether to use external FM appliance's second cache, based on workload information of itself and the FM appliance. The storage system gets the FM appliance workload information via the management network from the management computer or from the FM appliance itself. In one example, the storage system uses the first cache dirty ratio to ascertain the workload itself. The “too high workload” threshold is higher than the “quiet down” threshold to avoid fluctuation. In another example, the storage system uses the FM appliance first cache dirty ratio and FM pool used ratio. If the FM appliance first cache dirty ratio is higher than the threshold, or the FM appliance FM pool used ratio is higher than the threshold (i.e., free ratio is lower than threshold), the storage system reduces using 2nd cache in FM appliance and restricts input data amount from hosts by itself using the technologies such as delaying write response. The FM appliance may restrict write I/Os from the storage systems by delaying write response, if the workload is too high (e.g., dirty ratio is higher than the threshold).

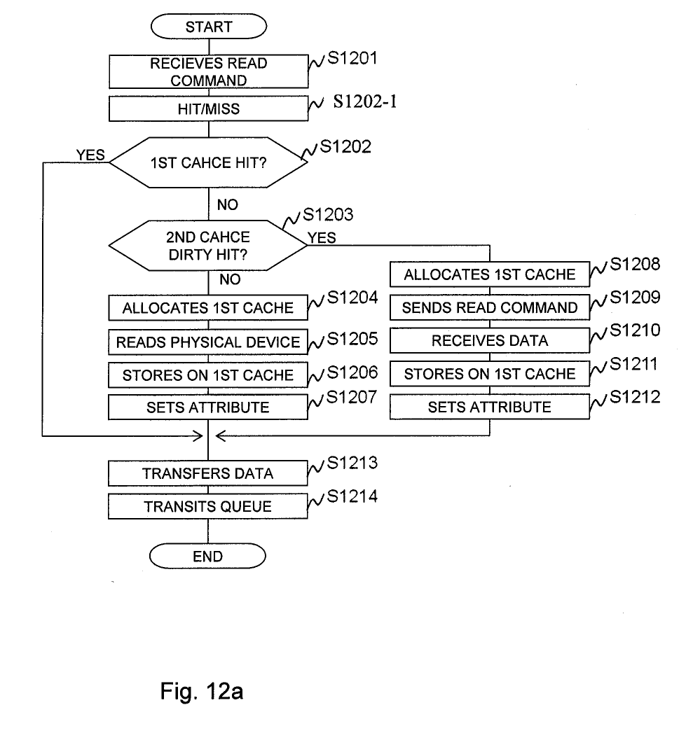

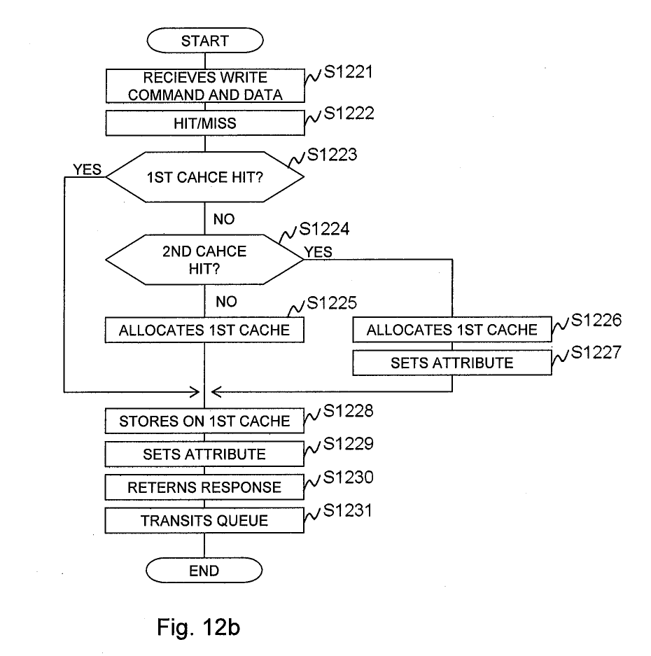

FIG. 12 shows examples of host I/O processing. More specifically, FIG. 12a shows an example of a flow diagram illustrating host read I/O processing during distribution/going back mode, and FIG. 12b shows an example of a flow diagram illustrating host write I/O processing during distribution/going back mode, according to the first embodiment. For simplicity, in this embodiment all blocks that are included in the host I/O command are of the same attribute (dirty/clean/free) in FIG. 12a. If the I/O area includes different attributes, the storage system uses each flow and combines data and transfers to host. The storage system sets the first cache attribute to clean after reading from the internal physical devices (permanent area). The storage system sets the first cache attribute to dirty after reading from the external FM appliance device (second cache). If there is second cache clean hit, the storage system can read from each internal physical area (permanent area) or external FM appliance device (second cache).

In FIG. 12a, the storage system receives a read command in S1201. The storage system checks cache hit (data already in cache) or cache miss in S1202. In S1202-1, the storage system determines whether there is a first cache hit. If yes, the storage system program skips to S1213. If no, the storage system determines whether the data is second cache dirty hit or not in S1203. If yes, the storage system performs S1208 to S1212. If no, the storage system performs S1204 to S1207. In S1208, the storage system allocates first cache. In S1209, the storage system sends the read command to the appliance. In S1210, the storage system receives data from the appliance. In S1211, the storage system stores data on the first cache. In S121, the storage system sets cache attribute (see, e.g., FIGS. 6a and 6b) based on which data segment is in cache. For instance, the LDEV#+SLOT#, first cache slot attribute, and first cache bitmap are updated. In S1204, the storage system allocates first cache. In S1205, the storage system reads physical device (i.e., hard disk drive). In S1206, the storage system stores data on first cache. In S1207, the storage system sets cache attribute. Then, the storage system transfers data to the host in S1213. In S1214, the storage system transits queue, which refers generally to changes to directory entry with reference to MRU (most recently used) and LRU (least recently used) pointers. In this example, a new directory entry is created in FIG. 6b and one of the directory entries is deleted in FIG. 6c.

In FIG. 12b, the storage system receives a write command in S1221. The storage system checks cache hit or cache miss in S1222. In S1223, the storage system determines whether the data is first cache hit or not. If yes, the storage system program skips to S1228. If no, the storage system determines whether the data is second cache hit or not in S1224. If yes, the storage system performs S1226 to S1227. If no, the storage system performs S1225. In S1225, the storage system allocates first cache. In S1226, the storage system allocates first cache. In S1227, the storage system sets cache attribute. In S1228, the storage system stores data on first cache. In S1229, the storage system sets cache attribute. In S1230, the storage system returns response. In S1231, the storage system transits queue.

For simplicity, in this embodiment all blocks that are included in the host I/O command are of the same attribute (dirty/clean/free) in FIG. 12b. If the I/O area includes different attributes, the storage system uses each flow per block. If there is second cache hit, the storage system sets the second cache attribute to “INVALID”.

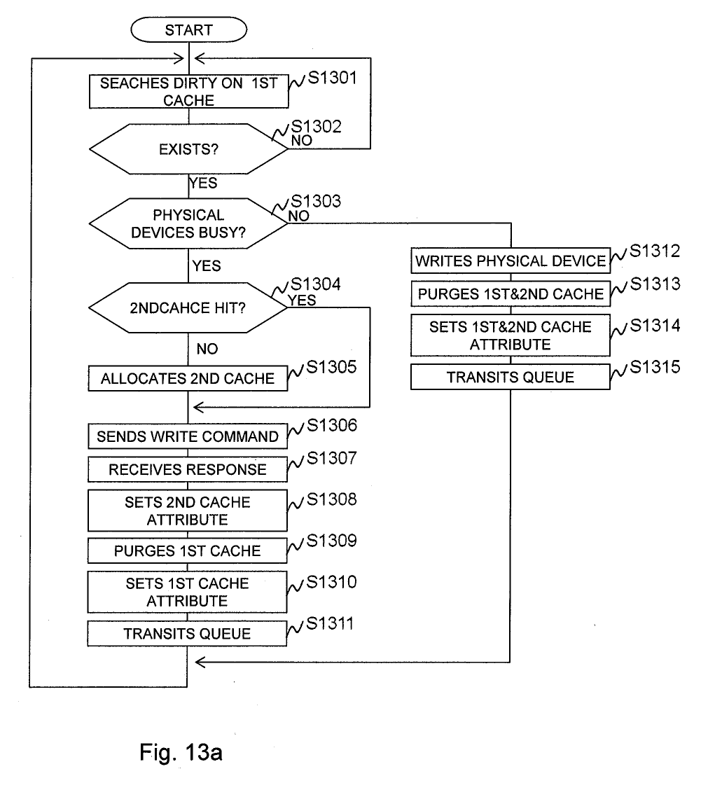

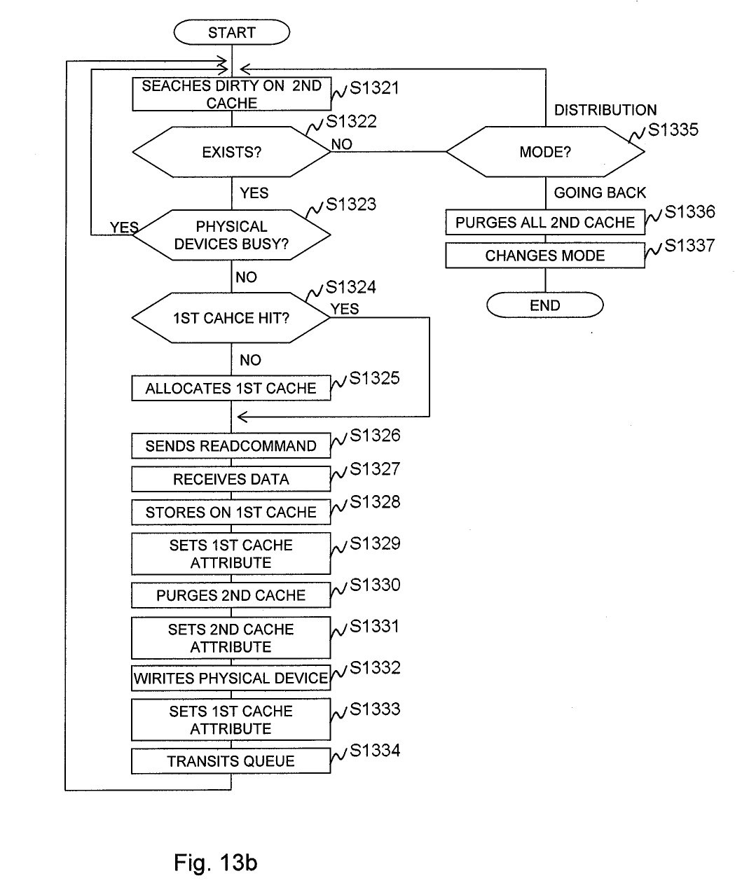

FIG. 13a shows an example of a flow diagram illustrating asynchronous cache transfer from first cache to second cache during distribution mode according to the first embodiment. If the physical device (permanent area) is not too busy, the storage system de-stages (write data) to it. If the physical device is busy, the storage system writes to the external second cache. When purging the second cache, the storage system sends SCSI write same (0 page reclaim) command to the FM appliance to release unused second cache area in the FM pool. During “going back mode”, the storage system does not transfer data from first cache to external second cache.

In S1301, the storage system searches dirty on the first cache. If none exists in S1302, the storage system program return to S1301; otherwise, the storage system determines whether the physical devices are busy in S1303. If yes, the storage system performs S1304 to S1311. If no, the storage system performs S1312 to S1315. In S1304, the storage system determines whether the data is second cache hit or not. If yes, the storage system program skips S1305. If no, the storage system allocates the second cache in S1305. In S1306, the storage system sends a write command to the appliance. In S1307, the storage system receives a response from the appliance. In S1308, the storage system sets the second cache attribute. In S1309, the storage system purges the first cache. In S1310, the storage system sets the first cache attribute. In S1311, the storage system transits queue. In this example, directory entry is deleted in the dirty queue of the first cache, directory entry is created in the free queue of the first cache, and directory entry is created in the dirty queue of the second cache. The storage system program then returns to S1301. In S1312, the storage system writes to the physical device. In S1313, the storage system purges the first cache and second cache. In S1314, the storage system sets the first cache attribute and the second cache attribute. In S1315, the storage system transits queue. In this example, directory entry is deleted in the dirty queue of the first cache and directory entry is deleted in the dirty queue of the second cache.

FIG. 13b shows an example of a flow diagram illustrating asynchronous data transfer from second cache to first cache during distribution and going back modes according to the first embodiment. If there is not any dirty on the second cache during the going back mode, the storage system purges all second cache areas (including INVALID attribute) and changes mode to the normal mode. It is possible that writing data to physical device (permanent area) and latter processes are done asynchronously.

In S1321, the storage system searches dirty on the second cache. If none exists in S1322, the storage system determines whether the mode of operation is distribution or going back in S1335. For distribution mode, the storage system program returns to S1321. For going back mode, the storage system purges all second cache in S1336, changes mode to normal in S1337, and ends the process. If some exists in S1322, the storage system determines whether the physical devices are busy in S1323. If yes, the storage system program returns to S1321. If no, the storage system performs S1324 to S1334. In S1324, the storage system determines whether the data is first cache hit or not. If yes, the storage system program skips S1325. If no, the storage system allocates the first cache in S1325. In S1326, the storage system sends a read command to the appliance. In S1327, the storage system receives data from the appliance. In S1328, the storage system stores data on the first cache. In S1329, the storage system sets the first cache attribute. In S1330, the storage system purges the second cache. In S1331, the storage system sets the second cache attribute. In S1332, the storage system writes to the physical device. In S1333, the storage system sets the first cache attribute. In S1334, the storage system transits queue. In this example, directory entry is deleted in the dirty queue of the first cache, directory entry is created in the free queue of the first cache, and directory entry is deleted in the dirty queue of the second cache. The storage system program then returns to S1321.

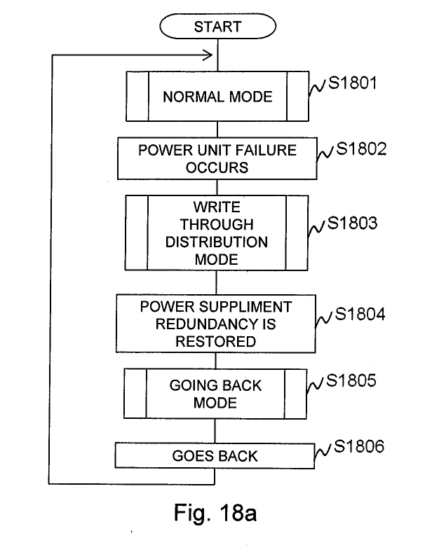

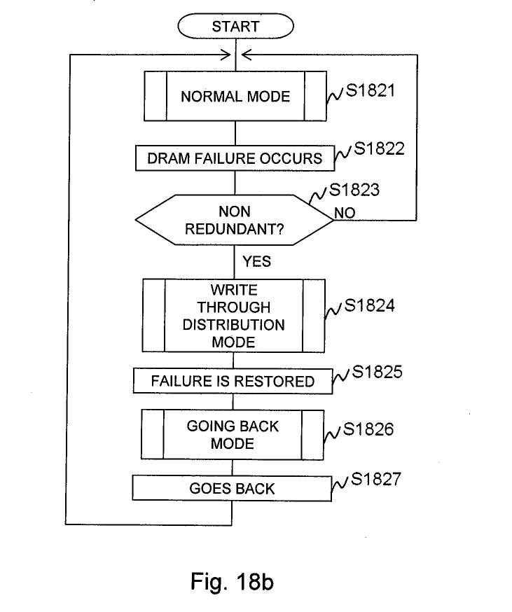

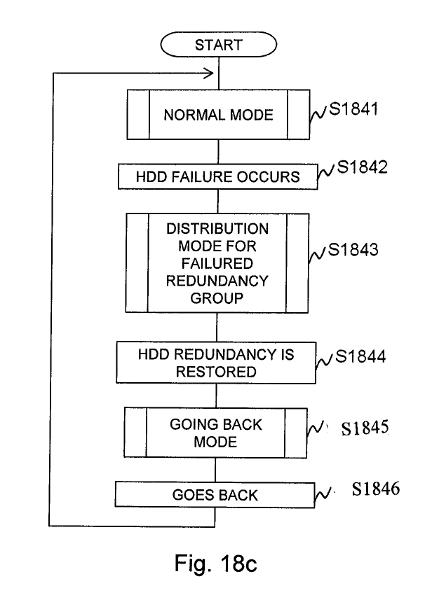

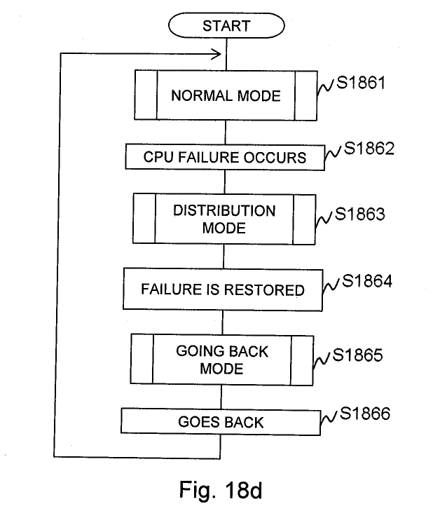

FIGS. 18a-18d illustrate mode transition by other reasons. FIG. 18a is a flow diagram illustrating an example of mode transition caused by power unit failure. The operation is normal mode (S1801). When the failure of the power-supply unit of a storage system occurs (S1802), the storage system will lose redundancy (lose cluster). During non-redundancy mode, the storage system may become write-through mode (not caching & writing-after mode) to avoid losing dirty data on DRAM (volatile memory). In write-through mode (S1803), the response performance to host is worse than that in the write-after mode because of HDD response performance. In this embodiment, the storage system switches the mode to one that uses the appliance, when power-supply unit failure occurs, because the FM appliance's response performance is better than that of HDD. The FM appliance is write-after mode. The storage system receives write data from the host and writes through from first DRAM cache to second external cache. The storage system asynchronously de-stages the second cache to HDD (via DRAM first cache). After restoration of the power-supply unit (getting back to have redundancy of power-supply) (S1804), the storage system switches to the going back mode (S1805) and goes back to the normal mode (S1806).

FIG. 18b is a flow diagram illustrating an example of mode transition caused by DRAM failure. The operation is normal mode (S1821). When the failure of DRAM (volatile memory) occurs (S1822), the storage system may lose redundancy of the first cache. If so, the storage system may become write-through mode same as non-redundancy mode caused by failure of the power-supply unit. When the failure occurs, the storage system checks the redundancy of the DRAM cache (S1823). If it loses redundancy, the storage system becomes write-through second cache mode (S1824) same as that in the power-unit failure case of FIG. 18a. After failure is restored (S1825), the storage system switches to going back mode (S1826) and goes back to normal mode (S1827).

FIG. 18c is a flow diagram illustrating an example of mode transition caused by HDD failure. The operation is normal mode (S1841). When the failure of HDD of the storage system occurs (S1842), the storage system will restore redundancy of the HDDs (rebuilding RAID). In case of HDD failure process, the HDDs become busier than usual because of correction read/write and rebuild processes. In this embodiment, the storage system switches the mode to one that uses the appliance, when HDD failure occurs to reduce HDD accesses. The mode is applied to the HDDs that make the redundancy group (RAID) with failure HDD. It is distribution mode for failure redundancy group (S1843). After HDD redundancy is restored (S1844), the storage system switches to going back mode (S1845) and goes back to normal mode (S1846).

FIG. 18d is a flow diagram illustrating an example of mode transition caused by CPU failure. The operation is normal mode (S1861). When the failure of the CPU of the storage system occurs (S1862), the dirty data amount on DRAM cache may increase, because the calculation of RAID parities or de-staging processing performance is reduced. In this embodiment, the storage system switches the mode to one that uses the appliance, when CPU failure occurs, to avoid DRAM becoming high workload ahead. It is distribution mode (S1863). After failure is restored (S1864), the storage system switches to going back mode (S1865) and goes back to normal mode (S1866).

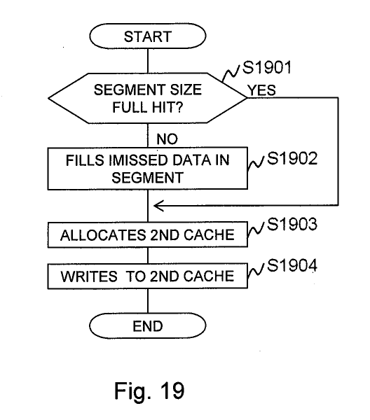

FIG. 19 is a flow diagram illustrating an example of filling the second cache. The storage system checks whether there is segment size full hit in S1901 (i.e., whether all data in segment exists in cache). The written data size from the host may be smaller than or out of alignment with respect to the second cache management unit (segment). In this embodiment, the storage system may read from the HDD and fill the missed data to the second cache (S1902). By filling the segment, in case of a host read process, the storage system does not have to read from the HDDs and merge with data on the second cache (thereby achieving better response performance). The storage system allocates the second cache (S1903) and writes to the second cache (S1904).

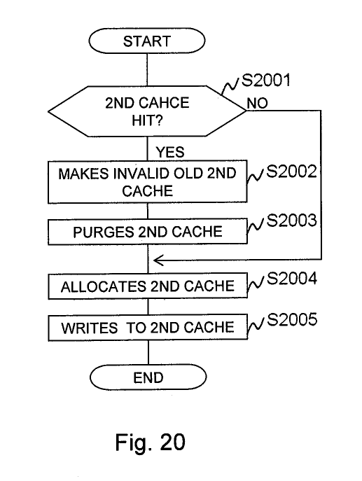

FIG. 20 is a flow diagram illustrating an example of allocating the second cache. In this embodiment, the storage system may allocate a new second cache area when receiving the update-write (2nd cache hit). This is good for not only performance but lifetime of the FM. Random write is worse than sequential write for FM lifetime. The storage system checks whether the data is second cache hit or not in S2001. If yes, the storage system makes invalid the old second cache (S2002) and purges the second cache (S2003). If no, the storage system skips S2002 and S2003. Then, the storage system allocates the second cache (S2004) and writes to the second cache (S2005).

### II. Second Embodiment

In the second embodiment, the storage system doubles as FM appliance. The storage system can have FM devices inside itself and uses them as permanent areas and/or second cache areas. In case of high workload, the storage system distributes other storage systems that have enough clean first cache area and second cache free area.

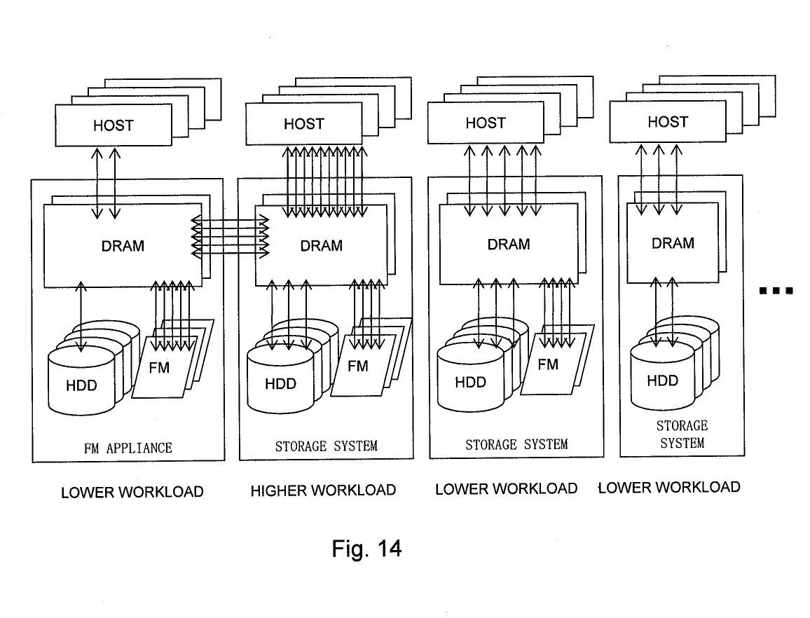

FIG. 14 illustrates an example of a hardware configuration of an information system according to the second embodiment.

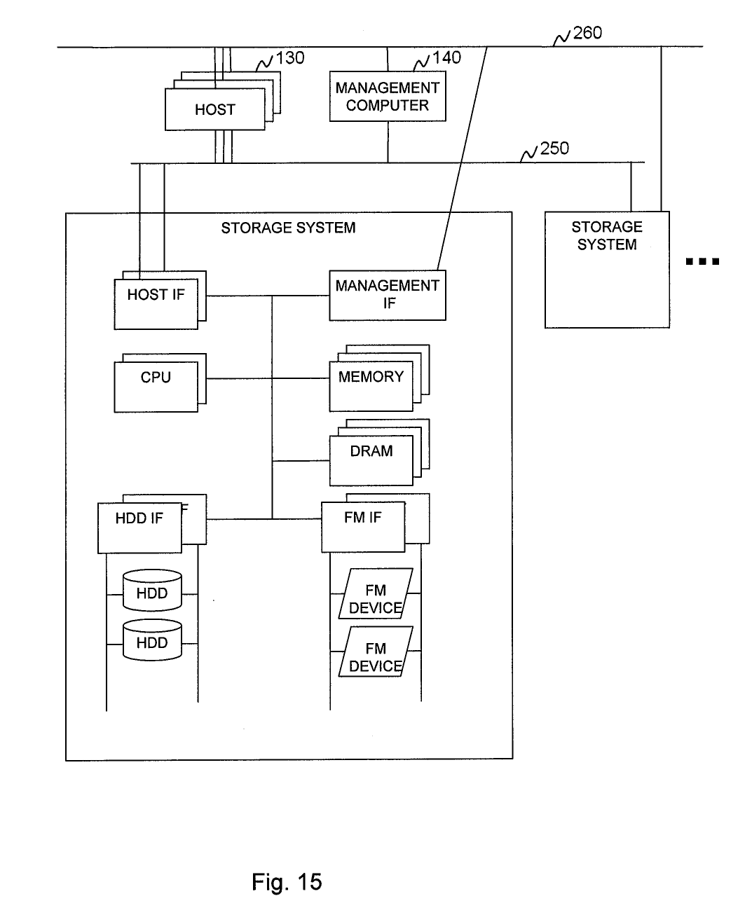

FIG. 15 illustrates further details of the physical system configuration of the information system of FIG. 14 according to the second embodiment. The storage system can have FM devices inside itself and use them as permanent areas and/or second cache areas.

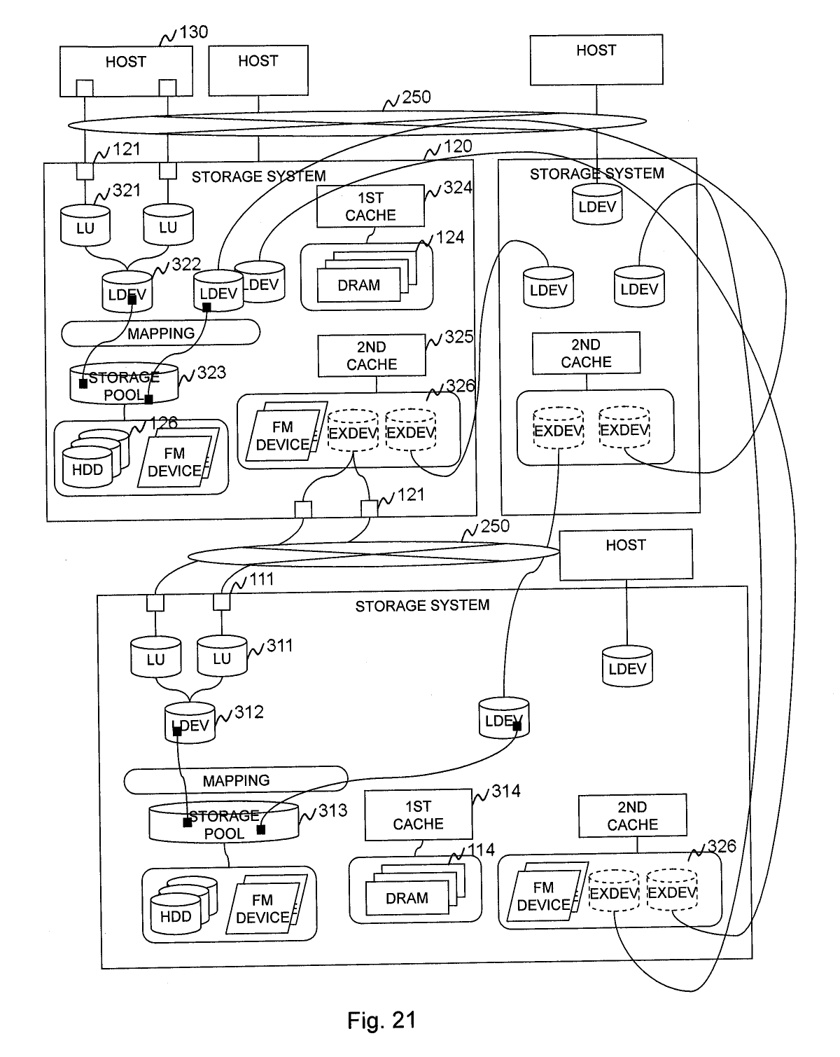

FIG. 21 illustrates an example of a logical configuration of the invention according to the second embodiment. Only the differences from the first embodiment of FIG. 3 are described here. The storage systems may have and use internal FM devices as permanent area (storage pool) and/or second cache area. The storage systems virtualize other storage systems' volumes as the second cache area with respect to each other. Those volumes are not accessed from the host.

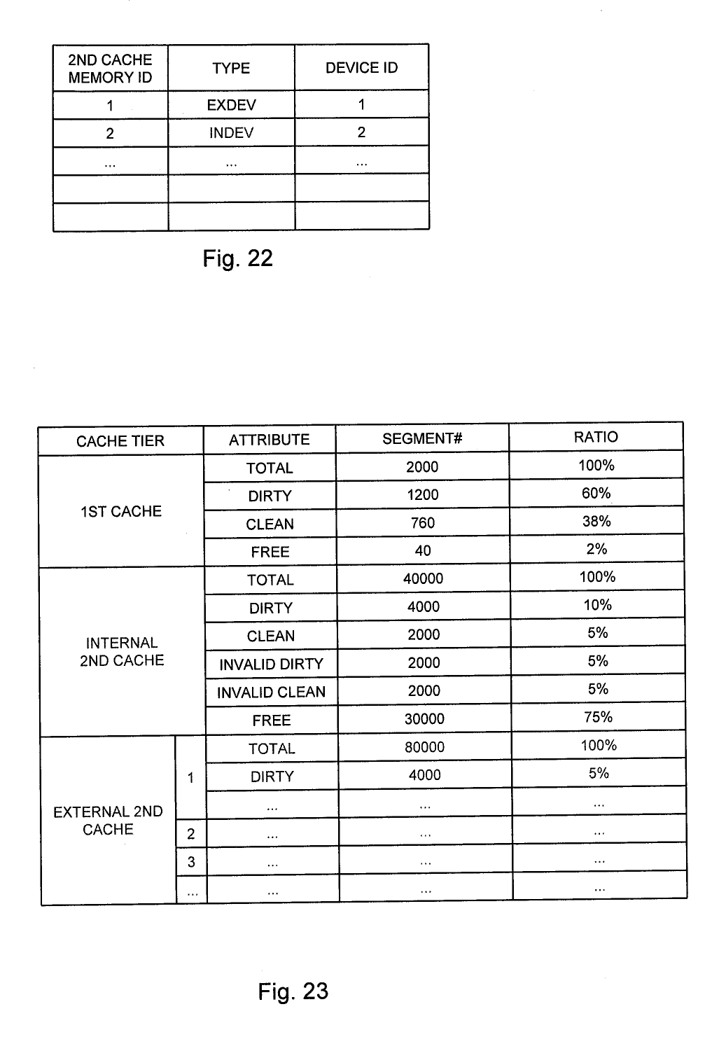

FIG. 22 shows an example of a second cache area information table according to the second embodiment. One difference between the second embodiment and the first embodiment of FIG. 5i is that the second cache consists of both external device and internal device.

FIG. 23 shows an example of a cache utilization information table according to the second embodiment. Only the differences from the first embodiment of FIG. 7 are described. The second cache consists of both external device and internal device. The external 2nd caches consist of multiple external devices.

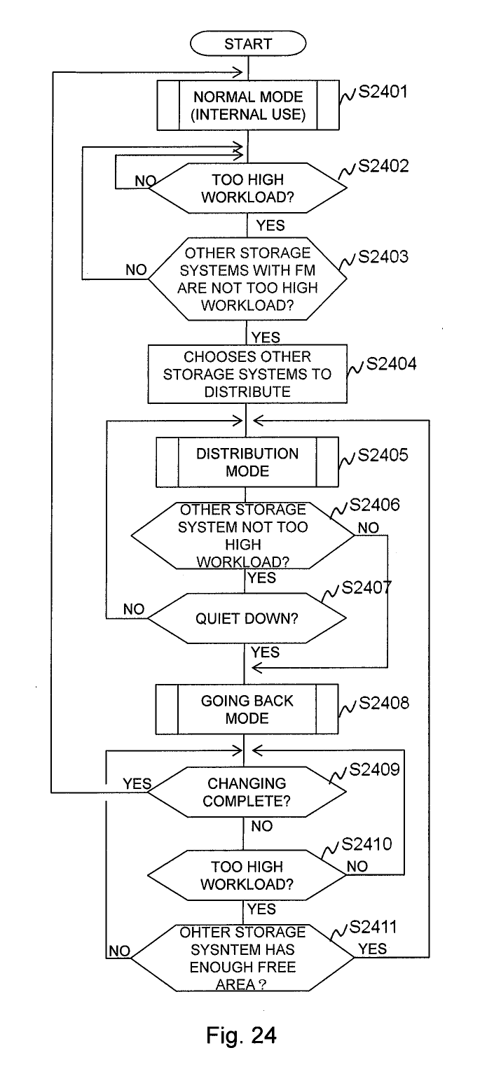

FIG. 24 shows an example of a flow diagram illustrating a process of mode transition according to the second embodiment. Only differences from the first embodiment of FIG. 11 are described. The storage system uses internal FM devices as the second cache in normal mode (S2401) if it has FM and internal second cache function. When the storage system becomes too high workload state (internal second cache dirty ratio is over the threshold) (S2402), nevertheless using internal second cache, it searches other storage systems that have FM devices and enough performance (or capacity or so) to be distributed workload (S2403), by communicating with each other or with the management computer. In S2404, it chooses other storage systems to distribute. Under the distribution mode (S2405), the storage system determines whether the other storage system is not to high workload (S2406) and whether the workload of storage system quiets down (S2407). Under the going back mode (S2408), the storage system determines whether there is changing complete (S2409), whether there is too high workload (S2410), and whether the other storage system has enough free area (S2411).

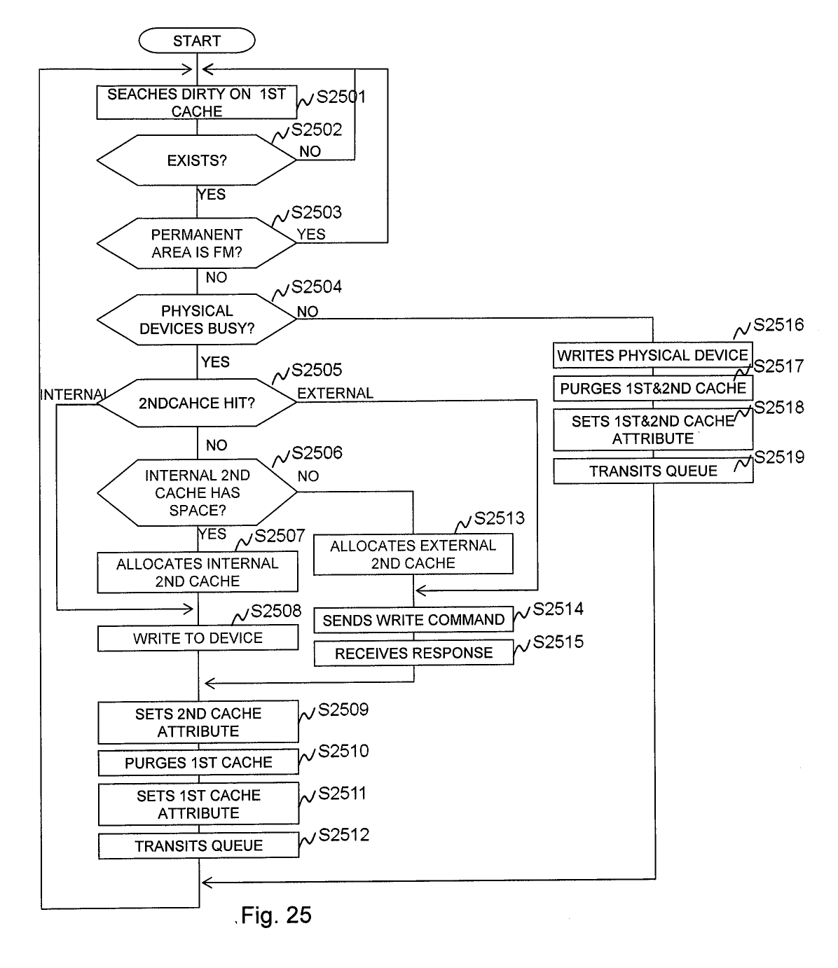

FIG. 25 shows an example of a flow diagram illustrating a process of asynchronous cache transfer according to the second embodiment. Only differences from the first embodiment of FIG. 13a are described. The storage system may use internal FM device as permanent area. If the discovered first cache dirty data's chunk is allocated FM device as permanent area, the storage system does not allocate and write to the second cache. The permanent area (internal FM) has good performance itself. The storage system checks hit/miss also internal or external second cache and switches the process. The storage system uses the internal second cache area prior to the external second cache.

S2501 and S2502 are the same as S1301 and S1302. In S2503, the storage system determines whether the permanent area is FM. S2504 and S2505 are the same as S1303 and S1304. S2516 to S2519 are the same as S1312 to S1315. In S2505, if the data is not hit on second cache, the storage system program proceeds to S2506; otherwise, the storage system program proceeds to S2508 for internal and to S2514 for external. In S2506, the storage system determines whether the internal second cache has space. If yes, the storage system allocates internal second cache in S2507 and proceeds to S2508. If no, the storage system allocates external second cache in S2513 and proceeds to S2514. In S2508, the storage system writes to device and proceeds to S2509. In S2514, the storage system sends write command and receives response in S2515, and then proceeds to S2509. S2509 to S2512 are the same as S1308 to S1311.

### III. Third Embodiment

In the third embodiment, external appliance is used as expanded first cache area.

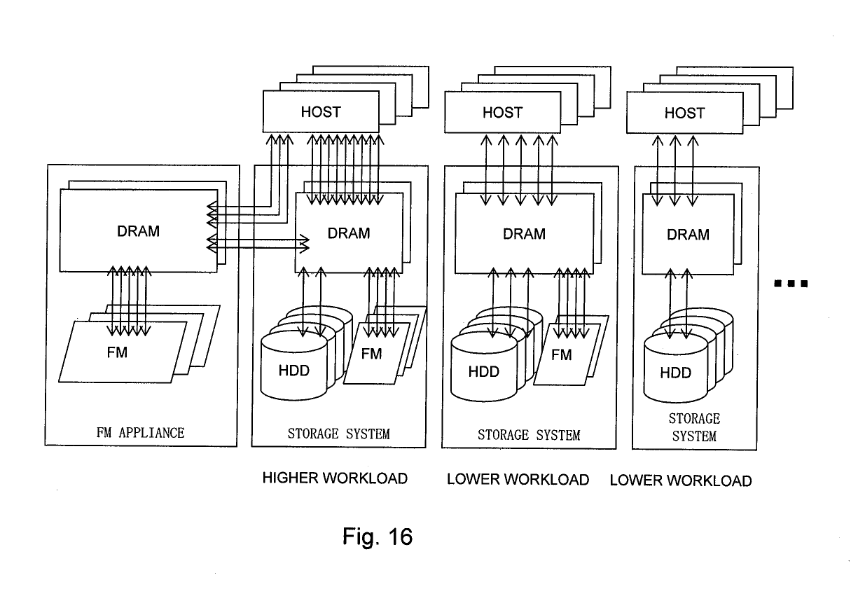

FIG. 16 illustrates an example of a hardware configuration of an information system according to the third embodiment. In case of high workload, the storage system uses the FM appliance as expanded first cache area. The storage system directly forwards received write data to the FM appliance (internal first cache-throw).

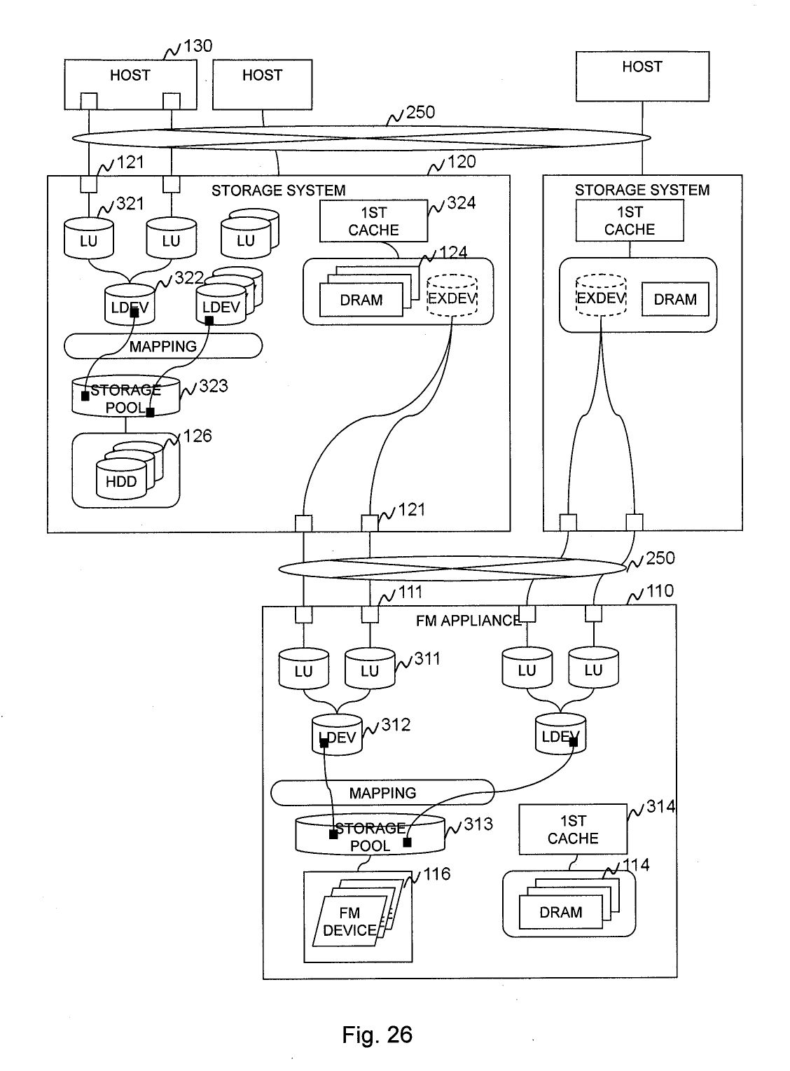

FIG. 26 illustrates an example of a logical configuration of the invention according to the third embodiment. One difference from the first embodiment of FIG. 3 is that the first cache of the storage system in FIG. 26 consists of internal DRAM and external devices. External first cache technology written in this embodiment may also apply to the first embodiment (external device as 2nd cache) and the second embodiment (using internal FM device as permanent and second cache, storage systems use other storage systems' resources with respect to each other).

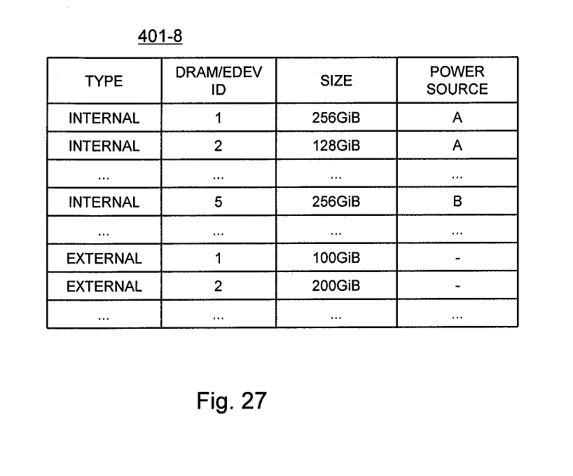

FIG. 27 shows an example of a first cache area information table according to the third embodiment. Only differences from the first embodiment of FIG. 5h are described. The first cache consists of both external device and internal device (DRAM).

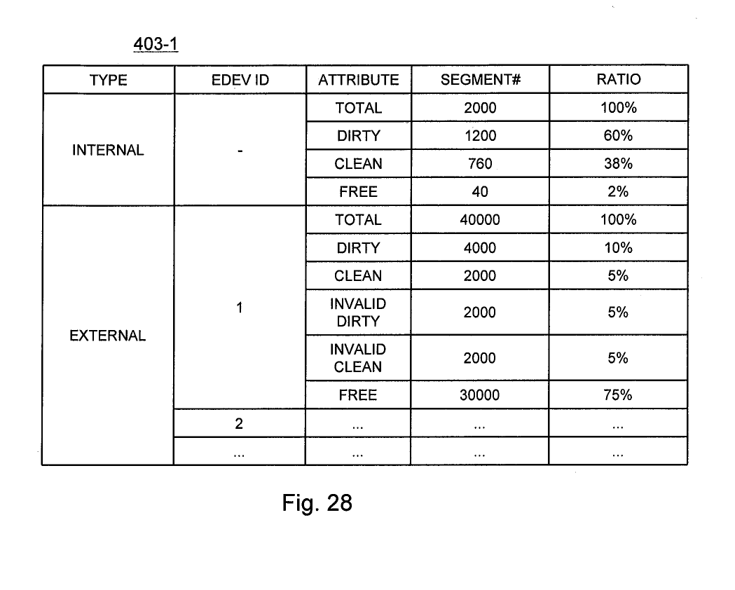

FIG. 28 shows an example of a cache utilization information table according to the third embodiment. Only differences from the first embodiment of FIG. 7 are described. The first cache consists of both external device and internal device.

There is a process of mode transition according to the third embodiment. Only differences from the first embodiment of FIG. 11 are described. During normal mode, the storage system uses only internal first cache, and does not use external first cache. During distribution mode, the storage system uses not only internal first cache but external first cache. During going back mode, the storage system uses not only internal first cache but external first cache. The storage system does not allocate more external first cache, and releases external first cache area that becomes clean attribute.

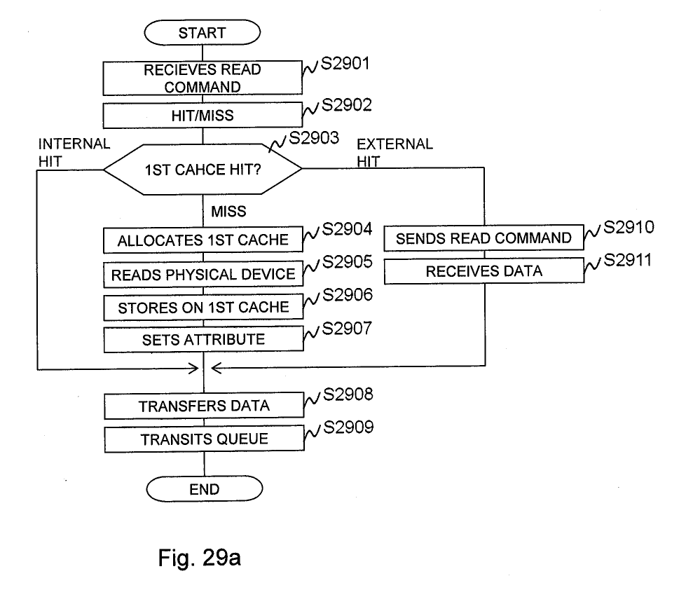

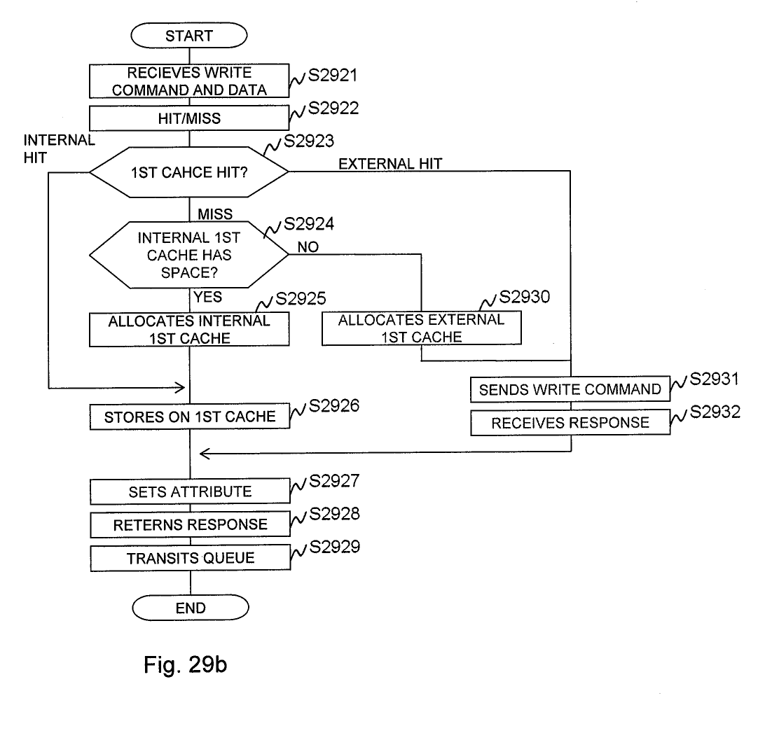

FIG. 29a shows an example of a flow diagram illustrating host read I/O processing during distribution/going back mode according to the third embodiment. Only differences from the first embodiment of FIG. 12a are described. When there is first cache hit, the program switches process along internal hit or external hit instead of following the miss flow path. In case of external hit, the storage system sends read command to the appliance (likely read second cache in the first embodiment). The storage system does not read data from external cache on internal cache (cache-through).

S2901 to S2903 are the same as S1201 to S1202. In S2903, if the data is first cache missed, the storage system performs S2904 to S2909.

If the data is internal hit, the storage system performs S2908 to S2909. If the data is external hit, the storage system performs S2910 to S2911 and then S2908 to S2909. S2904 to S2907 are the same as S1204 to S1207. S2910 to S2911 are the same as S1209 to S1210. S2908 to S2909 are the same as S1213 to S1214.

FIG. 29b shows an example of a flow diagram illustrating host write I/O processing during distribution/going back mode according to the third embodiment. Only differences from the first embodiment of FIG. 12b are described. When there is first cache hit, the program switches process along internal hit or external hit instead of following the miss flow path. In case of external hit, the storage system sends write command to the appliance, and does not store data on the internal first cache (write-through). In case of miss, the storage system judges whether the internal first cache has enough performance (or space) and, if not, the storage system allocates external first cache area and sends the write command thereto. The storage system sets the internal/external first cache attribute.

S2921 to S2923 are the same as S1221 to S1223. In S2923, if the data is a first cache missed, the storage system determines whether the internal first cache has space (S2924). If yes, the storage system allocates internal first cache (S2925) and then performs S2926 to S2929, which are the same as S1228 to S1231. If no, the storage system allocates external first cache (S2930) and performs S2931 to S2932 and then S2927 to S2929. The storage system sends the write command in S2931 and receives data in S2932. Back in S2923, if the data is internal hit, the storage system performs S2926 to S2929. If the data is external hit, the storage system performs S2931 to S2932 and then S2927 to S2929.

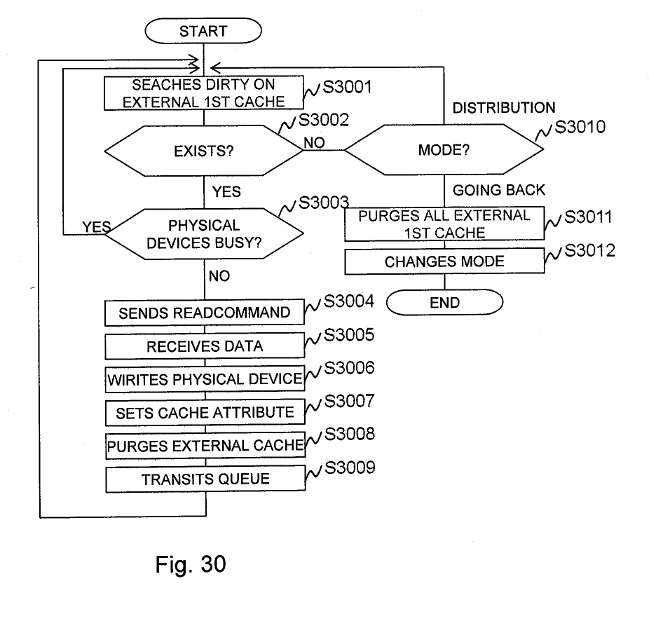

FIG. 30 is an example of a flow diagram illustrating a process of asynchronous data transfer from external first cache to permanent area during distribution and going back modes according to the third embodiment. Only differences from the first embodiment of FIG. 13b are described. The storage system searches external cache (not external second cache). The storage system does not store data in the internal first cache (write-through). It is possible to allocate the internal first cache area and asynchronously write to the permanent area.

In S3001, the storage system searches dirty on the external first cache. If none exists in S3002, the storage system determines whether the mode of operation is distribution or going back in S3010. For distribution mode, the storage system program returns to S3001. For going back mode, the storage system purges all external first cache in S3011, changes mode to normal in S3012, and ends the process. If some exists in S3002, the storage system determines whether the physical devices are busy in S3003. If yes, the storage system program returns to S3001. If no, the storage system performs S3004 to S3009. In S3004, the storage system sends a read command to the appliance. In S3005, the storage system receives data from the appliance. In S3006, the storage system writes to the physical device. In S3007, the storage system sets the cache attribute. In S3008, the storage system purges the external cache. In S3009, the storage system transits queue. Several of these steps are the same as those in FIG. 13b.

### IV. Fourth Embodiment

The fourth embodiment provides path switching between host and storage system via FM appliance.

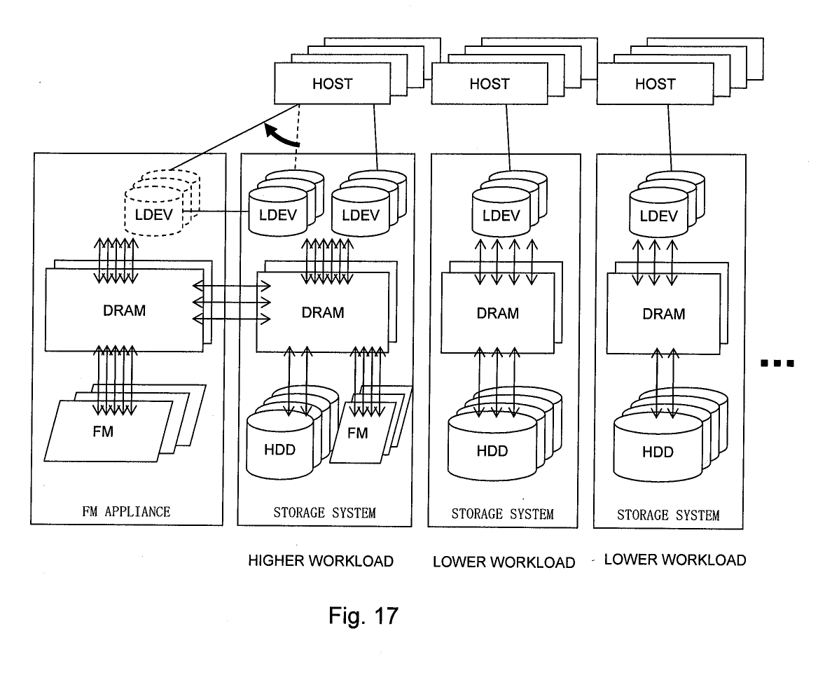

FIG. 17 illustrates an example of a hardware configuration of an information system according to the fourth embodiment. In case of high workload, the host accesses the storage system via the FM appliance. Port migration between storage system and FM appliance can be done using NPIV technology on storage port or other technologies.

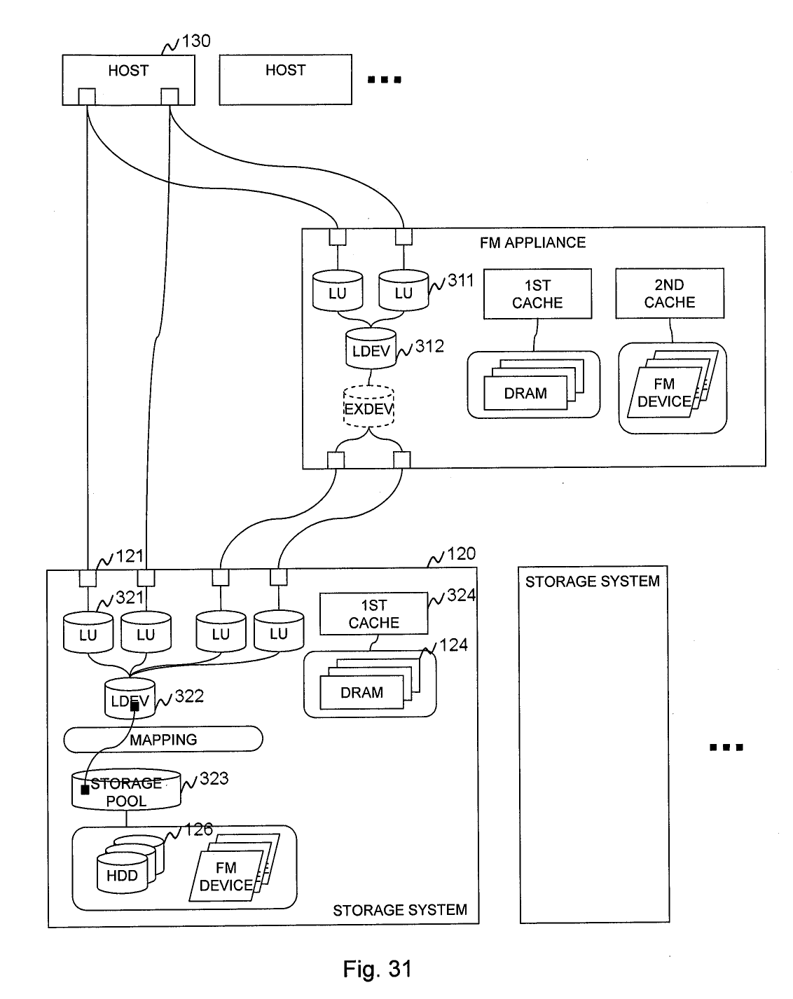

FIG. 31 illustrates an example of a logical configuration of the invention according to the fourth embodiment. Only differences from the first embodiment of FIG. 3 are described. The host accesses the storage system data via the appliance during distribution mode. The hosts have alternative paths of the storage system to the FM appliance. The appliance has external virtualization feature and virtualizes the storage systems' LDEV as an external device. The appliance has second cache feature using internal FM devices. It is possible to apply the second embodiment to this embodiment. Each storage system has FM appliance feature and can distribute workload with respect to each other.

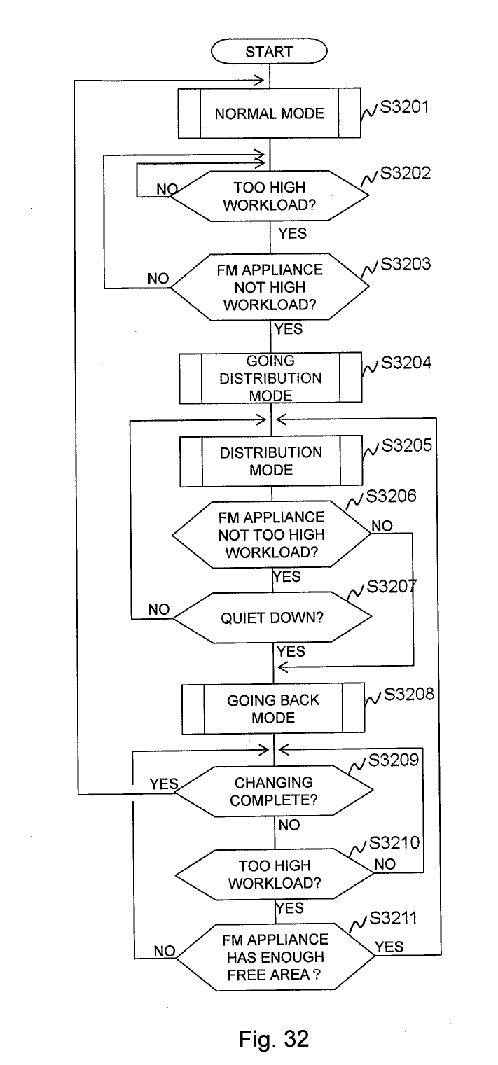

FIG. 32 shows an example of a flow diagram illustrating a process of mode transition according to the fourth embodiment. Only differences from the first embodiment of FIG. 11 are described. During normal mode (S3201), the host accesses the storage system directly. The mode changes to going distribution mode (S3204) if there is too high workload (S3202) and the FM appliance does not have high workload (S3203). During going-distribution mode (S3204), the host accesses the storage system both directly and via the FM appliance. The appliance reads from/writes to the storage system cache through during this mode, to keep data consistency between both access paths to the storage system. During distribution mode (S3205), the host accesses the storage system via the FM appliance. The appliance reads from the storage system missed data and transfers to host. The FM appliance stores written data from first cache to second cache, and asynchronously writes to the storage system. Because the written data is held together and written to the storage system, the workload of the storage system is reduced as compared to the case of accessing data directly. The mode changes to going back mode (S3208) if the FM appliance does not have too high workload (S3206) or the workload quiets down (S3207). During going back mode (S3208), the FM appliance synchronizes data with the storage system. The FM appliance writes cached data to the storage system and writes through newly received write data. After synchronization, the path returns to direct path to the storage system. Changing path can be done using techniques such as NPIV technology (Non-disruptive volume migration between DKCs as described, e.g., in US2010/0070722). The port is logged off from the storage system, and the virtual port# is switched at the FM appliance. If there are alternative paths, the FM appliance writes through till all paths are changed from the storage system to the FM appliance. It is possible to create paths using ALUA technology. It is possible to create alternative paths both direct and via the FM appliance in advance, and host multi-path software chooses to use which paths, by communicating with the storage system/FM appliance/management computer. For example, the management computer gets the cache state of the storage system and FM appliance, and indicates to the host which paths to use. If the mode changing completes in S3209, the storage system returns to normal mode S3201. If there is too high workload (S3210) and the FM appliance has enough free area (S3211), the storage system changes to distribution mode (S3205).

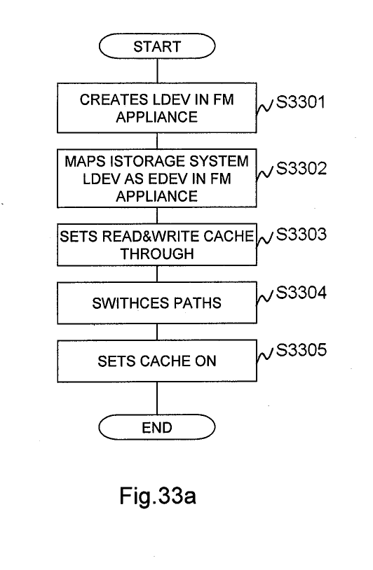

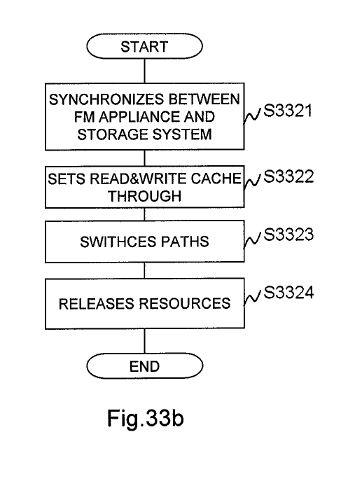

FIG. 33a shows an example of a flow diagram illustrating a process of path switching from normal mode to distribution mode according to the fourth embodiment. The FM appliance creates LDEV (S3301). It is possible that the management computer indicates to create LDEV to the FM appliance. The FM appliance connects to the storage system and maps the created LDEV to EDEV in the FM appliance (S3302). The FM appliance sets read and write cache through mode at the created LDEV (S3303) to keep data consistency during path switching (the host accesses both via the appliance and directly to the storage system). For example, with path migration using NPIV technology, the host switches the paths from host-FM appliance to host-storage system (S3304). It is also possible to use other methods such as creating and deleting alternative paths. After path switching, the FM appliance sets the cache feature for both first cache and second cache onto the LDEV (S3305).

FIG. 33b shows an example of a flow diagram illustrating a process of switching from distribution-mode (going back-mode) to normal-mode according to the fourth embodiment. The FM appliance synchronizes data with the storage system by writing first and second cached dirty data to the storage system and setting cache through mode to newly received written data (S3321). After synchronizing, the FM appliance sets read cache through mode to keep data consistency during path switching (S3322). The FM appliance and storage system switch the path to direct access to the storage system (S3323). After path switching, the FM appliance releases the resources that were allocated LDEV and EDEV during distribution-mode (S3324). The resources can be used for other distribution. The FM appliance and storage system delete the paths between them, if they do not use the paths.

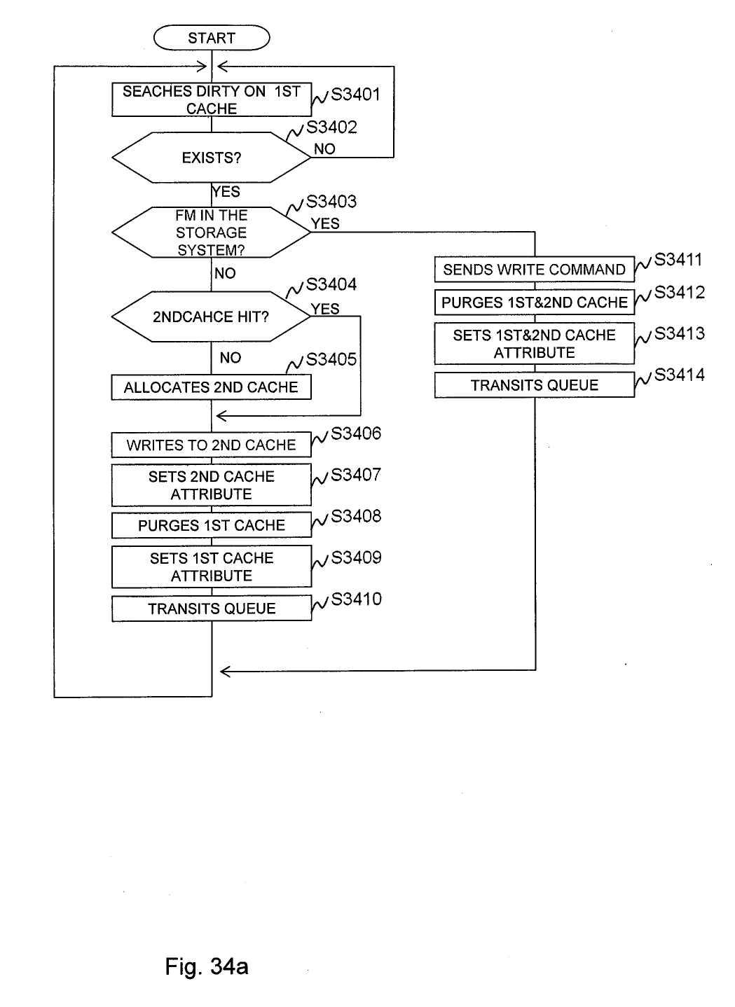

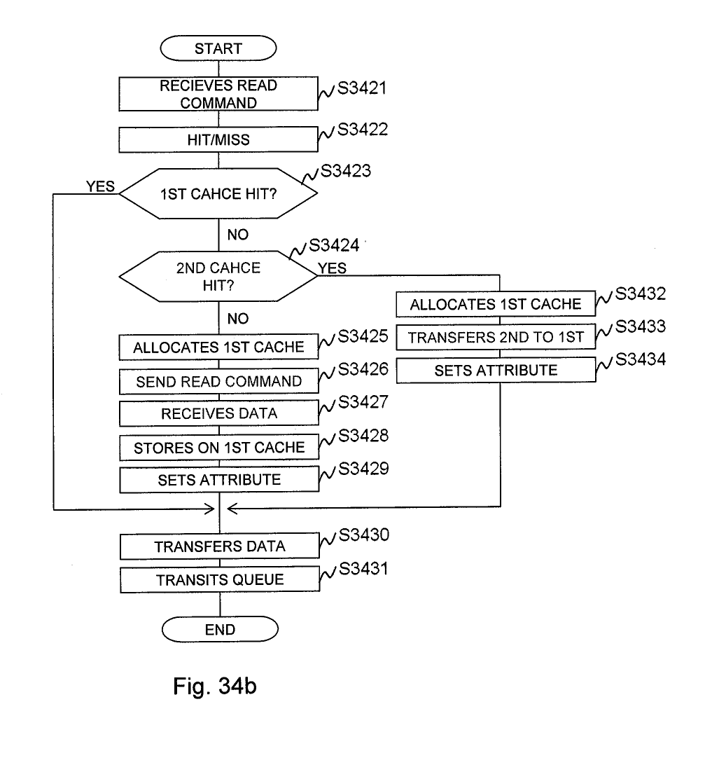

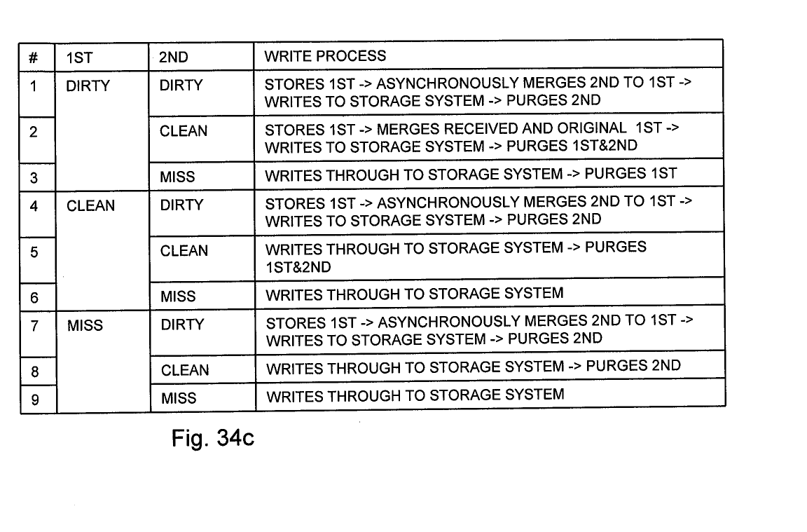

FIG. 34a shows an example of a flow diagram illustrating asynchronous cache transfer from first cache to second cache during distribution mode in the FM appliance according to the fourth embodiment. Only differences from the first embodiment of FIG. 13a are described. The process of the flow diagram of FIG. 34a is not carried out in the storage system, but in the FM appliance. Because the permanent data is in the external storage system, the FM appliance writes to the internal second cache area. The appliance gets the chunk allocation information in the storage system (which chunks are allocated in FM tier in the storage system). It is possible to communicate directly with the storage system or via the management computer. If the data is allocated FM device tier in the storage system, the appliance does not allocate the second cache in the FM appliance, but sends write command to the storage system, because the storage system may have enough power to be written.

S3401 to S3402 are the same as S1301 to S1302. In S3403, the storage system determines whether FM is in the storage system. If yes, the storage system performs S3411 to S3414. The storage system sends write command in S3411. S3412 to S3414 are the same as S1313 to S1315. If no, the storage system performs S3404 to S3410. S3404 to S3405 are the same as S1304 to S1305. In S3406, the storage system writes to the second cache. S3408 to S3410 are the same as S1308 to S1311.

There is asynchronous data transfer from second cache to permanent area during distribution mode in the FM appliance according to the fourth embodiment. Only differences from the first embodiment of FIG. 13b are described. The process of the fourth embodiment is not carried out in the storage system, but in the FM appliance. Because the permanent data is in the external storage system and second cache is in the FM appliance, the FM appliance reads from internal second cache area and sends write command to the external storage system.

FIG. 34b shows an example of a flow diagram illustrating host read I/O processing during distribution mode in the FM appliance according to the fourth embodiment. Only differences from the first embodiment of FIG. 12a are described. The process of the flow diagram of FIG. 34b is not performed in the storage system, but in the FM appliance. The FM appliance receives the I/O command from hosts during the distribution mode in this embodiment. Because the permanent data is in the external storage system, in case of cache miss, the FM appliance sends the read command to the storage system. Because the second cache is in the FM appliance (not in the external appliance), in case of second cache hit, the FM appliance reads from the internal second cache area. It is possible to treat read/write cache through (does not use first cache in FM appliance), in the case where the area (chunk) is allocated FM tier in the storage system. It is possible that the FM appliance does not care about the tier information in the storage system.

S3421 to S3425 are the same as S1201 to S1204. In S3426, the storage system sends read command. In S3427, the storage system receives data. S3428 to S3431 are the same as S1206, S1207, S1213, and S1214. S3432 is the same as S1208. In S3433, the storage system transfers from second to first cache. S3434 is the same as S1212.

FIG. 34c shows an example of a process pattern of a host write I/O processing during going back mode in the FM appliance according to the fourth embodiment. The FM appliance synchronizes the data using cache through. If the received data does not fill in segment and the data is dirty on the second cache, the FM appliance stores on the first cache and returns response to the host, asynchronously merges the first cache and second cache, and writes to the storage system.

### V. Fifth Embodiment

The fifth embodiment provides separated volume between the storage system and the FM appliance.

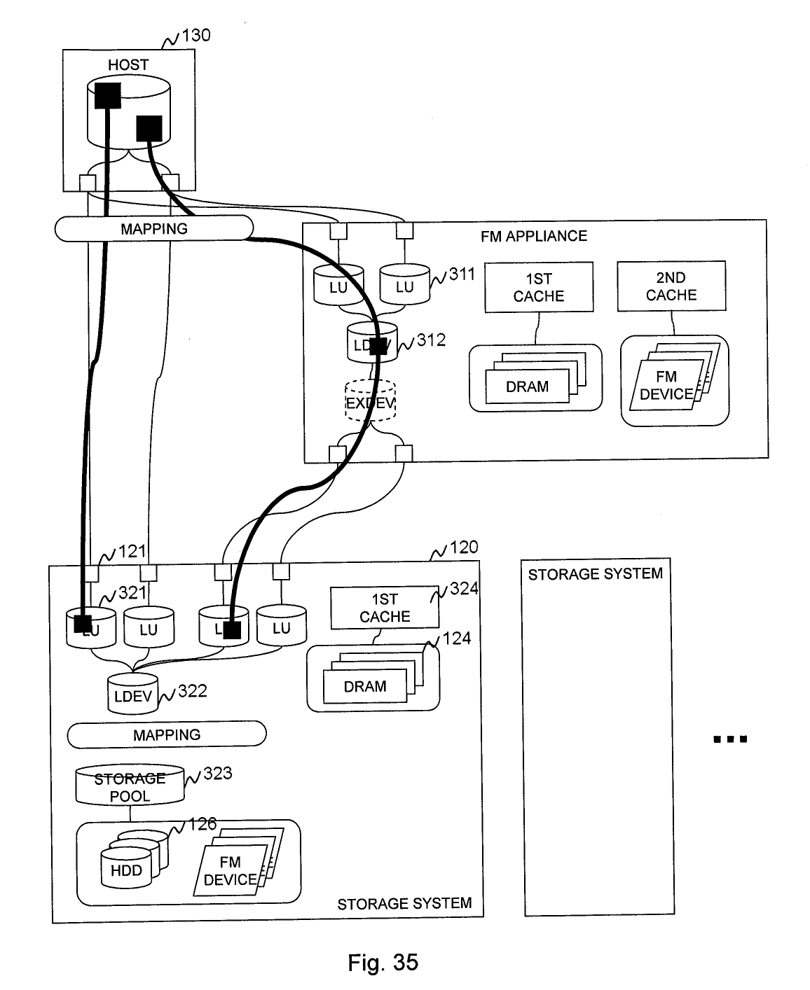

FIG. 35 illustrates an example of a logical configuration of the invention according to the fifth embodiment. Using SCSI Referral technology, the logical volume (LDEV) can be separated among several storage systems (the storage system has some volume area in charge) by LBA range.

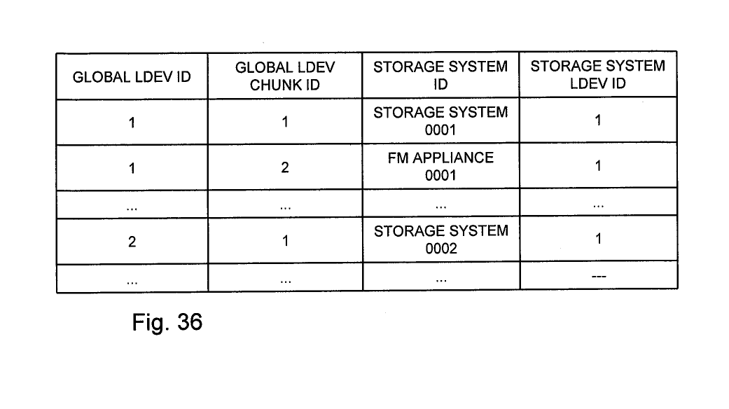

FIG. 36 shows an example of an information table of chunk distributed among several storage systems and FM appliances according to the fifth embodiment. Using SCSI Referral technology, the logical volume (LDEV) can be separated among several storage systems (the storage system has some volume area in charge). Global LDEV ID means the identification of volume among plural storage systems and FM appliances. During the distribution mode, some chunks are changed to a path via the FM appliance. In the fourth embodiment, the volume is changed to the FM appliance. In this embodiment, the change is not per volume but per chunk. Which chunk should be or should not be changed to the FM appliance depends on factors such as, for example, device tier in the storage system (HDD chunks should be changed to appliance and FM should not), I/O frequency in chunk, etc.

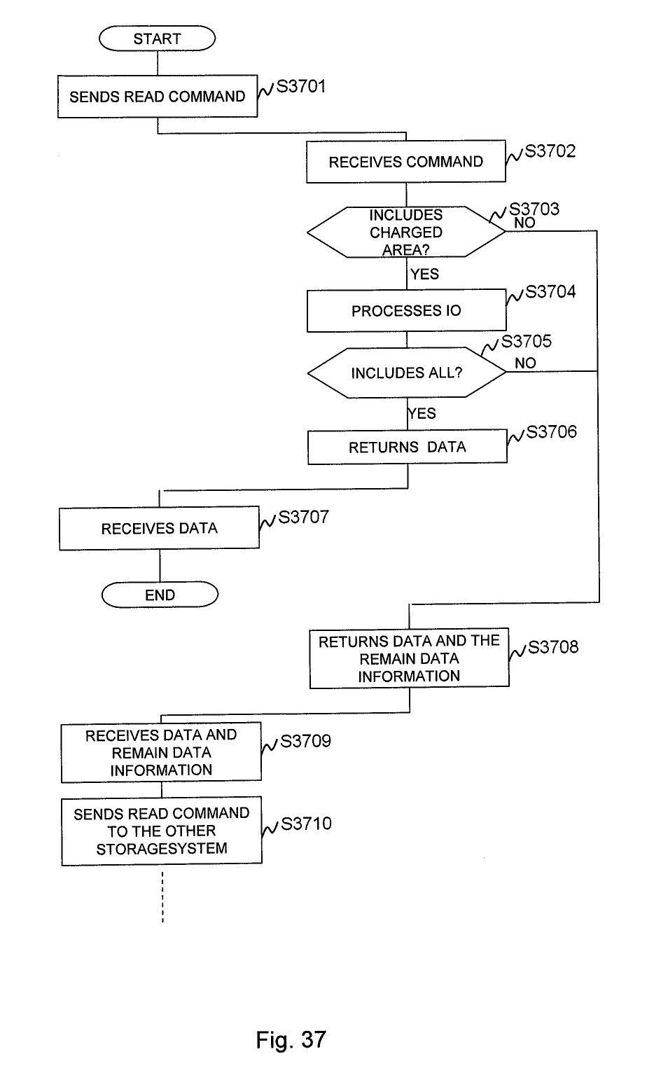

FIG. 37 shows an example of a flow diagram illustrating host read I/O processing in the case where a chunk is distributed among plural storage systems according to the fifth embodiment. Using SCSI Referral technology, the storage system (SCSI target) can return the other ports information, if the I/O address includes the address that is charged in other storage systems. The host sends a read command (S3701) to the storage systems which receive the command (S3702). A storage system checks whether the address is charged inside itself (S3703). If included, the storage system processes the read command (read from internal devices) (S3704) and returns data (S3706) to the host which receives the data (S3707). If the I/O address includes the address that is charged in another storage system (in this embodiment, FM appliance) (S3703) or if not all data is included (S3705), the storage system returns the remaining data address (LBA) and the address of the other storage system (FM appliance) (S3708). The host receives already processed data and remaining data information (S3709), and sends the other read command to get remaining data to the other storage system (FM appliance) (S3710). The host can keep the map information (which LBA is charged in which storage system), so that this flow may be first command to the FM appliance and second command to the storage system. Processing a write command is almost the same as processing a read command.

The requested data can be returned from the different port by using such as iSCSI technology. If the I/O address includes the address that is charged in other storage system, the storage system sends command to the other storage system that charges data to return data to host, and the storage system that receives the command from the storage system returns to the data to the host.

### VI. Sixth Embodiment

The sixth embodiment uses the FM appliance as high tier (chunk).

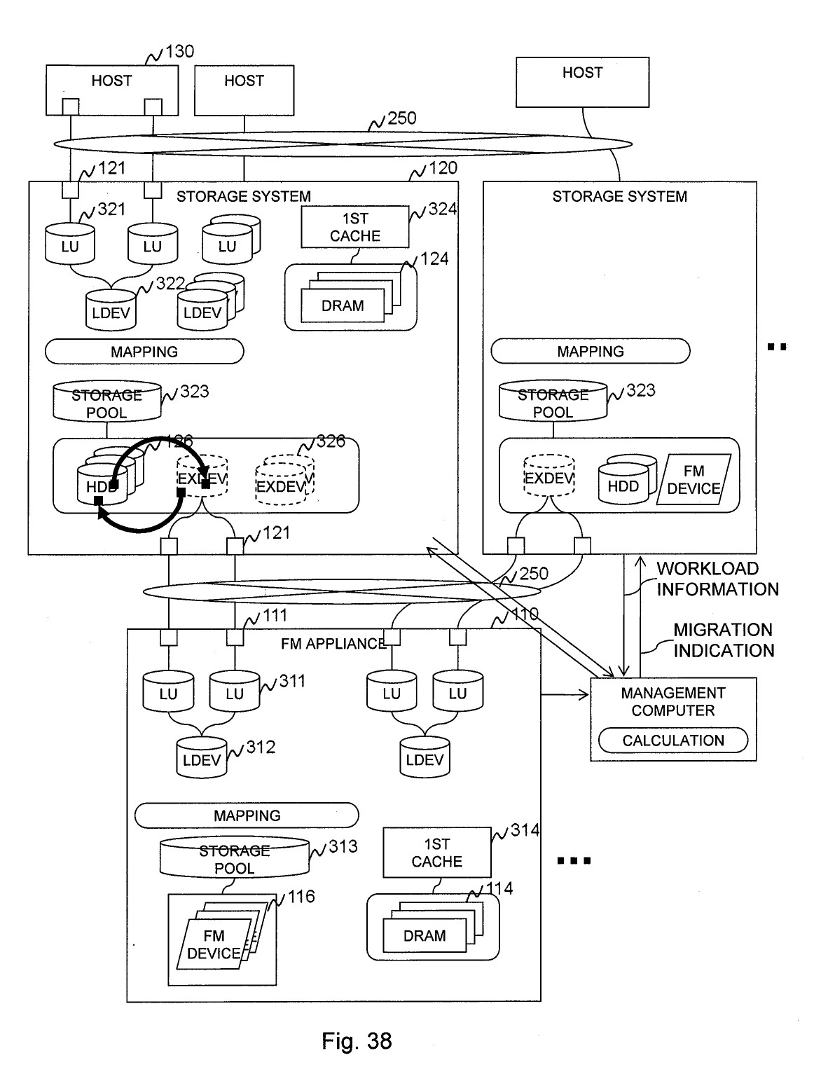

FIG. 38 illustrates an example of a logical configuration of the invention according to the sixth embodiment. Only differences from the first embodiment of FIG. 3 (and others) are described. The storage system uses the FM appliance as higher tier permanent area (not second cache). The management computer gets workload information from the storage systems and FM appliances, compares information and determines which chunks should be migrated, and indicates chunk migration. The storage system migrates chunks between tiers (between internal HDD and external FM).

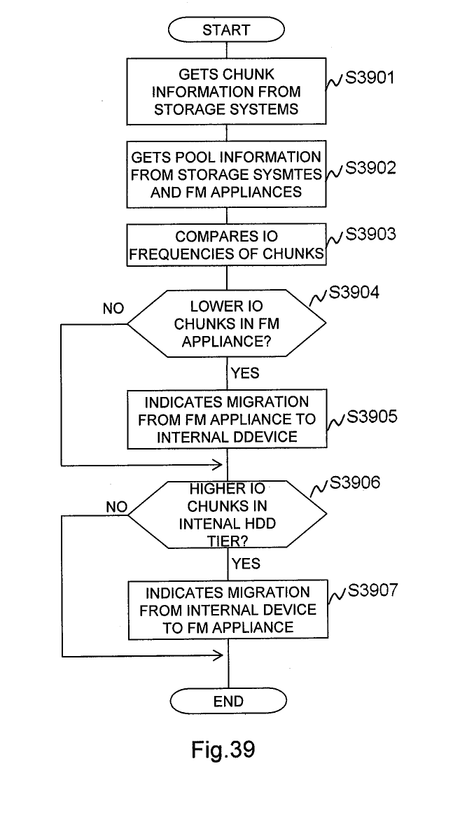

FIG. 39 shows an example of a flow diagram of the management computer according to the sixth embodiment. The management computer collects chunk information from the storage systems (S3901). The management computer gets pool information from the storage systems and FM appliances (S3902) and compares I/O frequencies of the chunks (S3903). The management computer searches the chunks that should be migrated by determining whether there is any chunk that is allocated to a lower tier internal device but has high I/O frequency and whether there is any chunk that is allocated to a higher tier FM appliance but has low I/O frequency (S3904 and S3906). The management computer indicates the storage systems to do chunk migration (S3905 and S3907). Such migration may be carried out from external FM appliance (higher tier) to internal HDD (lower tier), or from internal HDD to external FM appliance. It is possible that there is a range to avoid vibration of migration. Known technology such as automatic tiering may be used.

In this embodiment, the differences from the prior automatic tiering technology include the following. The prior technology is inside one storage system (including external storage system and just using one storage system). This embodiment involves technology used among plural storage systems. The external storage (FM appliance) is used from plural storage systems. In the prior technology, I/O frequencies of chunks are compared inside one storage system. In this embodiment, I/O frequencies of chunks are compared among plural storage systems. Higher frequency in storage system A may be lower frequency in storage system B, which can be caused by unbalanced workload among the storage systems. Furthermore, it is possible that the migration judging and indicating feature of the management computer is inside each storage systems or FM appliance.

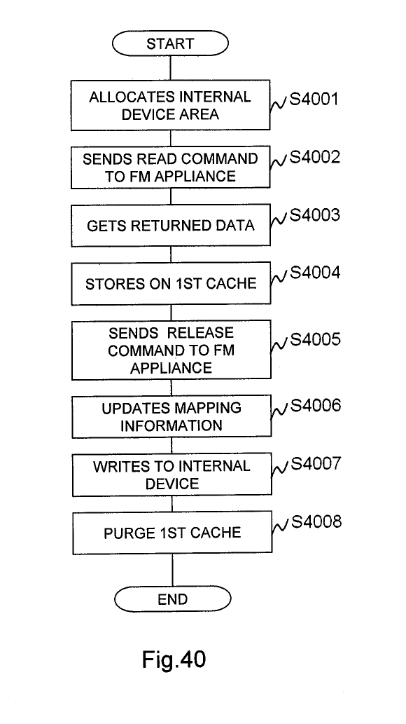

FIG. 40 shows an example of a flow diagram illustrating a process of chunk migration from external FM appliance to internal device in the storage system according to the sixth embodiment. The storage system copies the chunk data (reads chunk data from FM appliance and writes to internal device). The storage system releases the used chunk in the FM appliance by sending a release command (SCSI write same command). The released area in the FM appliance can be used by other storage systems. If the storage system also migrates from internal device to FM appliance, the storage system can use the FM appliance area without releasing it. The storage system allocates internal device area (S4001), sends read command to the FM appliance (S4002), gets returned data (S4003), and stores data on the first cache (S4004). The storage system sends the release command to the FM appliance (S4005), updates mapping information (S4006), writes to the internal device (S4007), and purges the first cache (S4008).

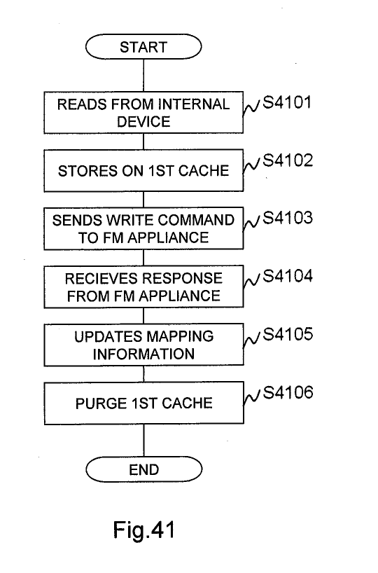

FIG. 41 shows an example of a flow diagram illustrating a process of chunk migration from internal device in the storage system to external FM appliance according to the sixth embodiment. The storage system copies the chunk data (reads chunk data from internal device and writes to FM appliance). The FM appliance allocates physical area to the thin-provisioned volume when it receives the write command, if it has not been allocated physical area yet. The storage system reads from the internal device (S4101), stores data on the first cache (S4102), sends write command to the FM appliance (S4103), receives response from the FM appliance (S4104), updates mapping information (S4105), and purges the first cache (S4106).

### VII. Seventh Embodiment

The seventh embodiment involves volume/page migration. This embodiment combines features the fourth and fifth embodiments. In the fourth and fifth embodiments, the FM appliance is used between the host and storage system as cache, and the permanent storage area is in the storage system. In this embodiment, the permanent area will be migrated.

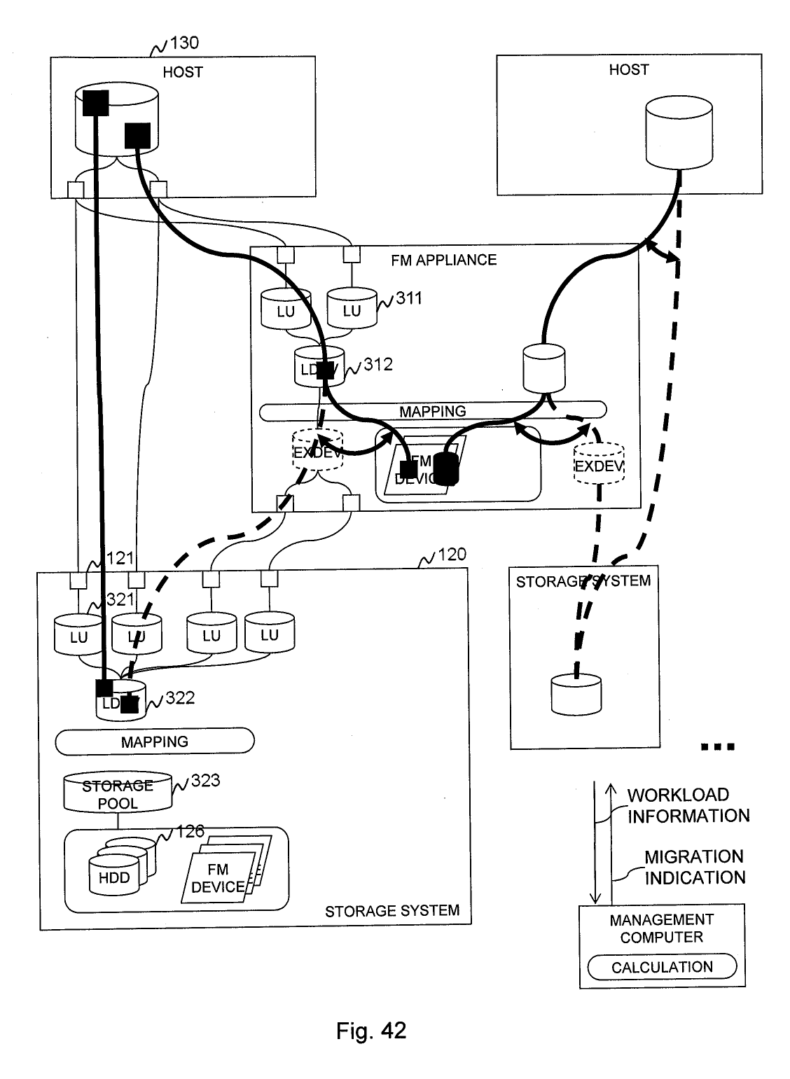

FIG. 42 illustrates an example of a logical configuration of the invention according to the seventh embodiment. Only differences from the first embodiment of FIG. 3 are described. Volumes are migrated between the storage system and FM appliance internal device (right side). Chunks are migrated between the storage system and FM appliance internal device (left side). The management computer gets workload information from the storage systems and FM appliances, compares information and determines which chunks/volumes should be migrated, and indicates migration (similar to the sixth embodiment). Not only the storage systems but the FM appliances have LDEVs that consist of internal devices (FM).

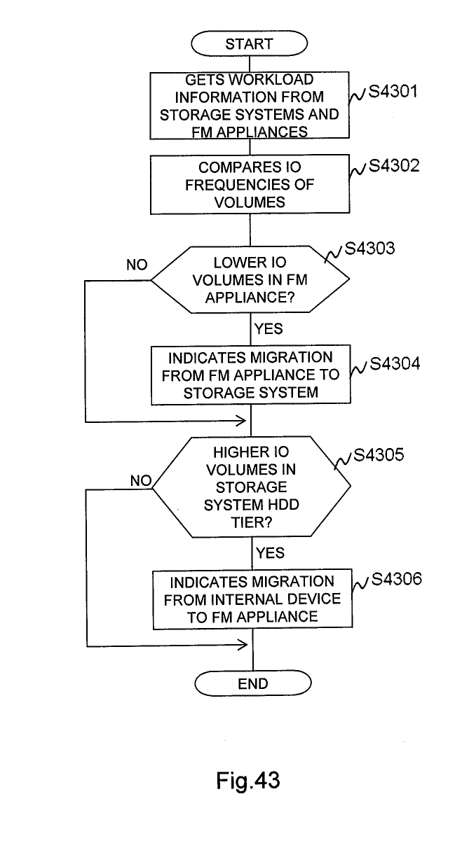

FIG. 43 shows an example of a flow diagram illustrating a process of the management computer to distribute workload with volume migration according to the seventh embodiment. Only differences from the sixth embodiment of FIG. 39 are described. The management computer gets the workload information of each volume (or each port) in the storage systems and FM appliances. The management computer indicates both migration initiator and target (storage system and FM appliance). The management computer gets workload information from the storage systems and FM appliances (S4301) and compares the I/O frequencies of the volumes (S4302). If there are lower I/O volumes in the FM appliance (S4303), the management computer indicates migration from the FM appliance to the storage system (S4304). If there are higher I/O volumes in the storage system HDD tier (S4305), the management computer indicates migration from the internal device to the FM appliance (S4306).

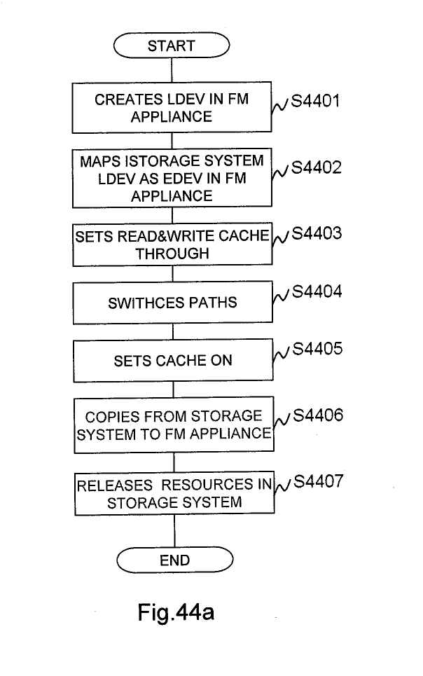

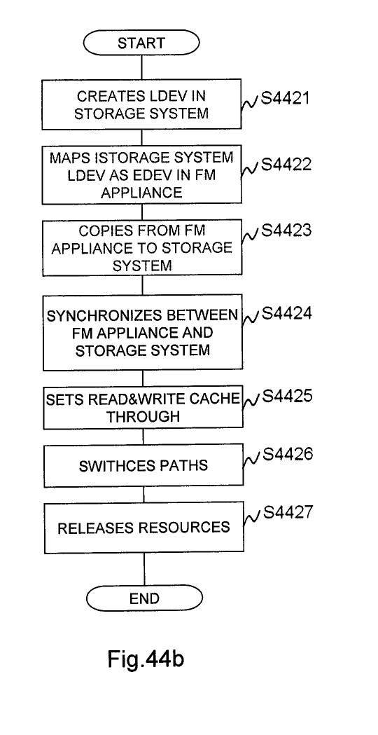

FIG. 44a shows an example of a flow diagram illustrating a process of volume migration from storage system to FM appliance according to the seventh embodiment. Only differences from the fourth embodiment of FIG. 33a are described. S4401 to S4405 are the same as S3301 and S3305. After the path switching (S4404) and the cache feature is on (S4405), the FM appliance copies data from the storage system to internal devices (sends read command to storage system and writes to internal devices) (S4406). By exchanging the information of LDEV chunk allocation between the storage system and the FM appliance, the FM appliance copies only allocated chunk data in the storage system. It is good for reducing copying time and performance, and utilization of pool in the FM appliance. After copying data, the storage system releases the resources that were allocated to migration source volume (S4407). They can be used as other volumes. The FM appliance and storage system delete the path between them. To release resources in the storage system, the FM appliance may send a release command (write same command) to the storage system or a LDEV deletion command.

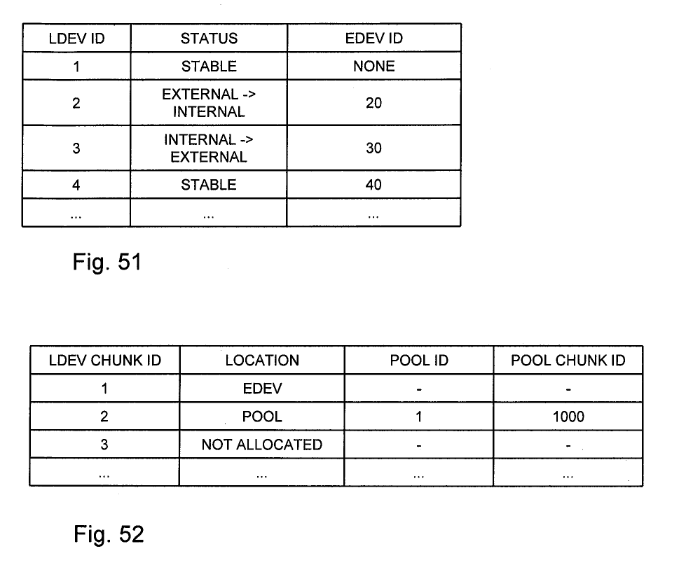

FIG. 51 shows an example of an information table of LDEV in the FM appliance according to the seventh embodiment. LDEV ID is the ID in the FM appliance. Status shows migration status of the LDEV. EDEV is the volume that virtualizes the volume in the storage system. After copying all allocated data in the storage system and deleting the connection between the LDEV in the FM appliance and EDEV, EDEV ID becomes NONE.

FIG. 52 shows an example of an information table of LDEV chunk in the FM appliance. It is possible that not all allocated data in the storage system are migrated (copied) to the FM appliance, but just only high workload data chunks are migrated to the FM appliance.

FIG. 44b shows an example of a flow diagram illustrating a process of volume migration from the FM appliance to the storage system according to the seventh embodiment. Only differences from the fourth embodiment of FIG. 33b are described. S4424 to S4427 are the same as S3321 to S3324. Before synchronizing (S4424), if there is not LDEV in the storage system, the storage system creates LDEV (S4421). The FM appliance connects to the storage system and maps the created LDEV to EDEV in the FM appliance (S4422). The FM appliance copies data from the migration source (internal devices) to the migration target (EDEV mapped storage system) by reading internal devices and sending a write command to the storage system (S4423).

There is a process of the management computer to distribute workload with chunk migration according to the seventh embodiment. Only differences from the volume migration of FIG. 43 are described. The management computer gets the workload information of each chunk (instead of volume or port) in the storage system and FM appliances.

There is a process of chunk migration from the storage system to the FM appliance according to the seventh embodiment. Only differences from the volume migration of FIG. 44a are described. The program does not switch paths to the FM appliance, but the host accesses both the storage system and FM appliance. The storage system and FM appliance change the chunk map from the storage system to the FM appliance. By using SCSI Referral technology, the storage system can return the host FM appliance address if the requested data is not mapped on itself but in the FM appliance. The FM appliance copies (migrates) the chunk data, not all volume data, from EDEV to internal devices. After chunk migration, the resources that were allocated to migration source chunks are released.

There is a process of chunk migration from the FM appliance to the storage system according to the seventh embodiment. Only differences from the volume migration of FIG. 44b are described. The program does not need to create LDEV in the storage system. The LDEV already exists in storage system. The storage system and FM appliance change the chunk map from the FM appliance to the storage system. The FM appliance copies (migrates) the chunk data, not all volume data, from internal devices to storage system (EDEV). After chunk migration, the resources that were allocated to migration source chunks are released.

### VIII. Eighth Embodiment

The eighth embodiment involves volume group to be distributed together. The storage system distributes per the LDEVs group, when the workload becomes higher in the storage system. It is possible that the user indicates the group, or the storage system decides itself. Example of volume group that storage system can decide is the group of storage system feature such as remote-copy consistency group, local copy volume pair, or the like.

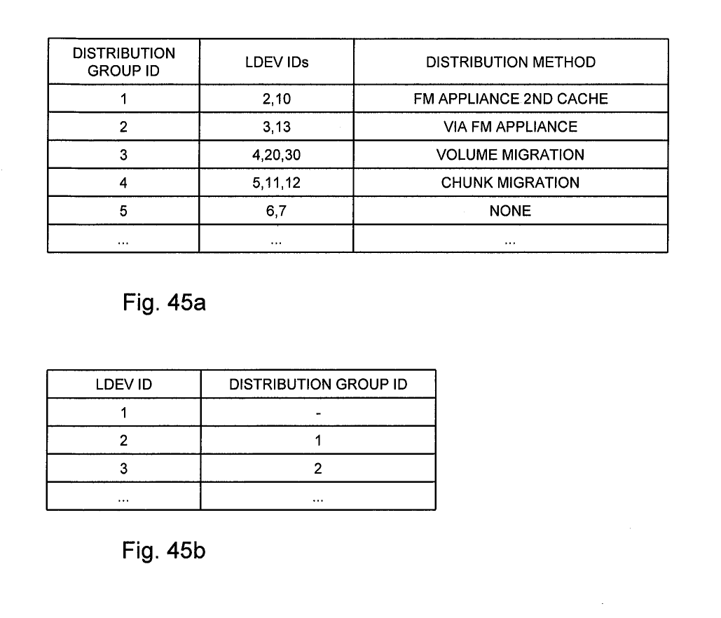

FIG. 45a shows an example of an information table of LDEV group and distribution method according to the eighth embodiment. The storage system has this table. It is possible that there are some methods to distribute workload, such as external cache, path switching, and migration. It is possible that there are groups that are not distributed. For example, the user may not want to distribute the data, because the risk of physical failure will be increased when the data is separated into storage system and appliance. As another example, the FM appliance does not have the same feature of the storage system applying to the volumes such as remote-copy, local-copy, or the like.

FIG. 45b shows an example of mapping of LDEV to LDEV group according to the eighth embodiment. It is possible that some volumes are not included in any group.

### IX. Ninth Embodiment

The ninth embodiment involves reservation of the FM appliance. If the user can forecast when high workload occurs (e.g., periodically), the resource of the FM appliance is reserved for that timing.

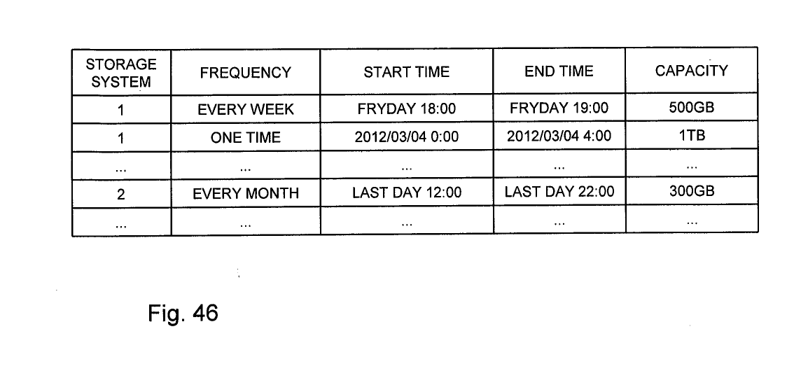

FIG. 46 shows an example of an information table of reservation according to the ninth embodiment. The management computer has this information table to judge whether the FM appliance has enough capacity to allocate when the storage system requests to use the FM appliance. It is possible that the FM appliance has this table. It is better that the management computer has this table in case there are plural FM appliances in the system. The user can set the reservation by the management computer's user interface. It is possible that the storage system or FM appliance has such user interface. It is possible that the FM appliance is used not only as cache but high tier (permanent area).

### X. Tenth Embodiment

In the tenth embodiment, the server uses the FM appliance.

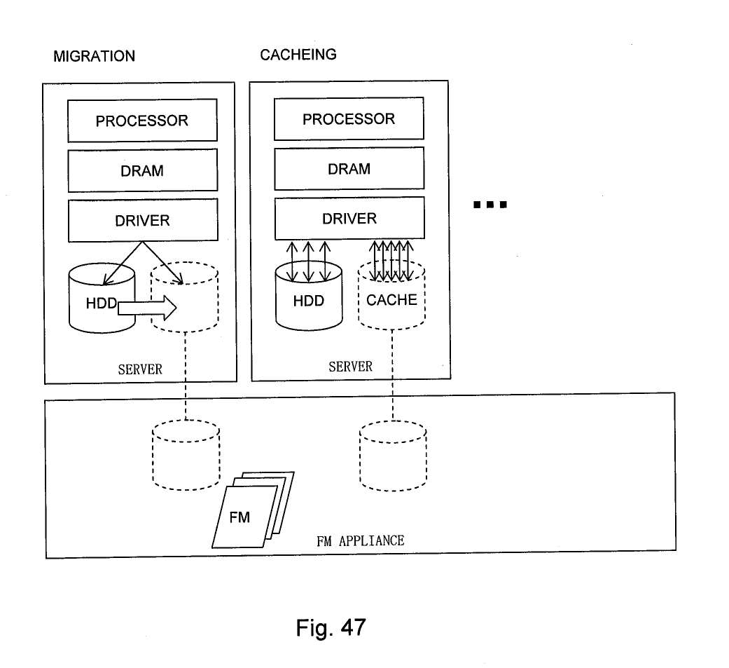

FIG. 47 illustrates an example of a logical configuration of the invention according to the tenth embodiment. Only differences from the first embodiment of FIG. 3 are described. The FM appliance does not have DRAM cache and directly accesses the FMs. The servers connect to the FM appliance using, for example, PCIe interface. The servers use the area on the FM appliance as migration target (left side) or cache of internal HDD (right side). It is possible that the servers are the storage systems. It is possible that the FM appliance may not have DRAM cache in the previous embodiments.

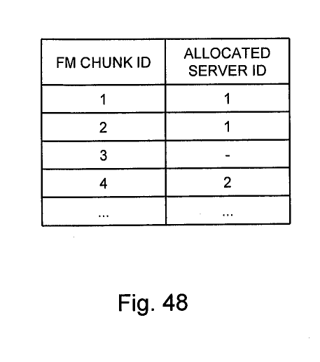

FIG. 48 shows an example of information of allocation of the FM appliance according to the tenth embodiment. The FM appliance manages which FM area is allocated or not, and allocated to which servers.

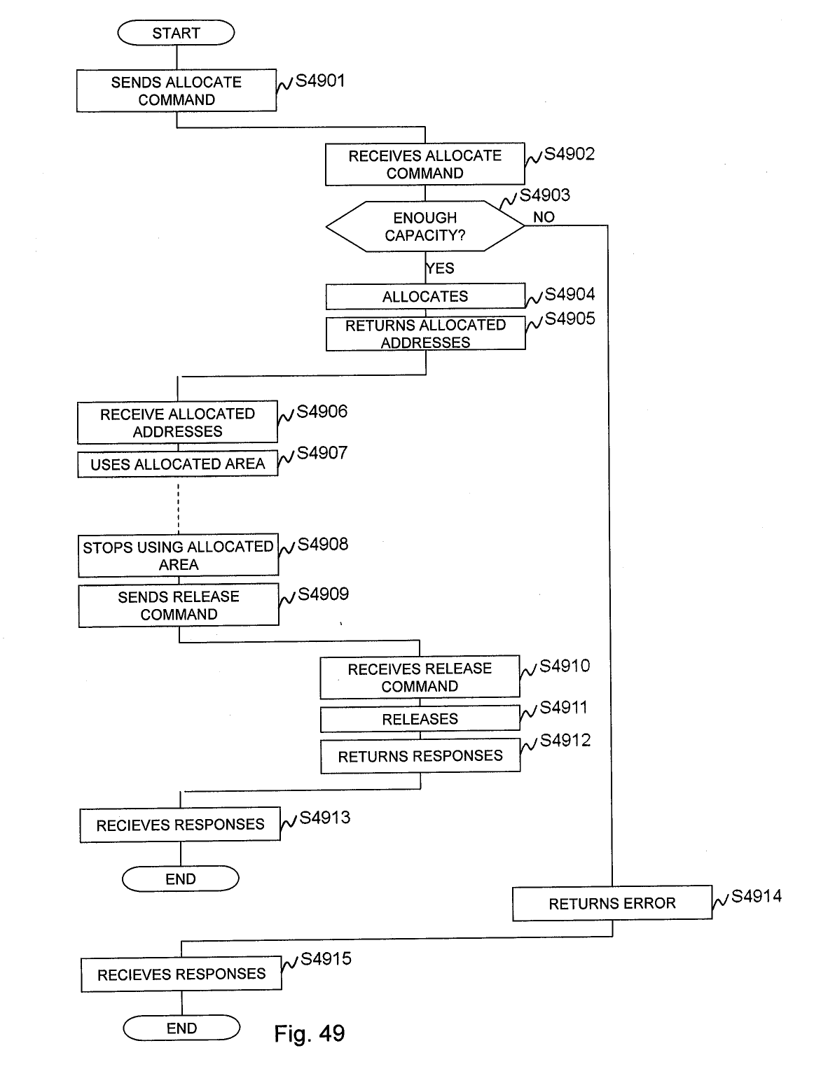

FIG. 49 shows an example of a flow diagram illustrating a process of allocating and releasing FM appliance area according to the tenth embodiment. The server sends (S4901) the FM appliance an allocate command to allocate area (S4902). If the FM appliance has enough capacity (S4903), it allocates area (S4904) and returns the allocated addresses (S4905) to the server which receives the allocated addresses (S4906). The server uses the allocated address (S4907). After the server does not have to use the appliance area (S4908), it sends the release command (S4909) to the FM appliance which receives the release command (S4910) and releases the area (S4911), and the area can be used by other servers. The FM appliance returns responses (S4912) to the server (S4913). If there is not enough capacity in S4903), the FM appliance returns error (S4914) to the server (S4915).

Other embodiments involving additional ideas and/or alternative methods are possible. The storage system may use the same FM device as both permanent area and second cache area. Switching path can be done by using T11 SPC-3 ALUA (Asymmetric Logical Unit Access) technology. The host, storage system, and FM appliance make additional alternative path via the FM appliance. The appliance can use other media, such as PRAM (Phase change RAM) or all DRAM. The host can be a NAS head (file server).

Of course, the system configurations illustrated in FIGS. 1, 14, 16, and 17 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for load distribution among storage systems using solid state memory as expanded cache area. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A system comprising:
a first storage system; and
a second storage system;
wherein the first storage system changes a mode of operation from a first mode to a second mode based on load of process in the first storage system;
wherein the load of process in the first storage system in the first mode is executed by the first storage system; and
wherein the load of process in the first storage system in the second mode is executed by the first storage system and the second storage system.

2. The system of claim 1,
wherein the first mode is normal mode and the second mode is high workload mode;
wherein the first storage system has a first cache area provided by first storage devices and a second cache area provided by second storage devices having higher performance than the first storage devices;
wherein during normal mode of operation, I/O (input/output) access to the first storage system is via the first cache area and not via the second cache area for each storage system; and
wherein the first storage system changes from the normal mode to the high workload mode if the first storage system has an amount of first cache dirty data in a first cache area which is higher than a first threshold, and the I/O access to the first storage system is through accessing a second cache area for the first storage system.

3. The system of claim 2,
wherein the mode of operation switches from high workload mode to normal mode for the first storage system if the amount of first cache dirty data in the first cache area rises above the first threshold and then falls below a second threshold.

4. The system of claim 2,
wherein the first cache area is provided by first storage devices in the first storage system and the second cache area is provided by second storage devices in the second storage system.

5. The system of claim 1,
wherein the second storage system is an appliance having higher performance resources than resources in the first storage system;
wherein the first mode is normal mode and the second mode is high workload mode;
wherein during normal mode of operation, I/O (input/output) access to the first storage system is direct and not via the appliance; and
wherein the first storage system changes from the normal mode to the high workload mode if the first storage system has an amount of first cache dirty data in a first cache area which is higher than a first threshold, and the I/O access to the first storage system is through accessing the appliance during the high workload mode.

6. The system of claim 5,
wherein the mode of operation switches from high workload mode to normal mode if the amount of first cache dirty data in the first cache area rises above the first threshold and then falls below a second threshold.

7. The system of claim 5,
wherein the first cache area is provided by first storage devices in the first storage system and second storage devices in the appliance.

8. The system of claim 5,
wherein the first cache area is provided by first storage devices in the first storage system, wherein the appliance has a second cache area provided by second storage devices having higher performance than the first storage devices, and wherein in the high workload mode, the I/O access to the first storage system is through accessing the second cache area.

9. The system of claim 5,
wherein the first cache area is provided by a logical volume which is separated between the first storage system and the appliance, the logical volume including chunks provided by the first storage system and the appliance.

10. The system of claim 5,
wherein the first cache area is provided by first storage devices in the first storage system, and wherein the appliance provides high tier permanent area, and wherein in the high workload mode, the I/O access to the first storage system is through accessing the high tier permanent area.

11. The system of claim 5,
wherein the first cache area is provided by a first logical volume which is separated between the first storage system and the appliance and a second logical volume, the first logical volume including chunks provided by the first storage system and the appliance, the second logical volume provided by the appliance.

12. A first storage system comprising:
a processor;
a memory;
a plurality of storage devices; and
a mode operation module configured to change a mode of operation from a first mode to a second mode based on load of process in the first storage system;
wherein the load of process in the first storage system is executed by the first storage system in the first mode; and
wherein the load of process in the first storage system is executed by the first storage system and a second storage system in the second mode.

13. The first storage system of claim 12,
wherein the first mode is normal mode and the second mode is high workload mode;
wherein the first storage system has a first cache area provided by first storage devices and a second cache area provided by second storage devices having higher performance than the first storage devices;
wherein during normal mode of operation, I/O (input/output) access to the first storage system is via the first cache area and not via the second cache area for each storage system; and
wherein the first storage system changes from the normal mode to the high workload mode if the first storage system has an amount of first cache dirty data in a first cache area which is higher than a first threshold, and the I/O access to the first storage system is through accessing a second cache area for the first storage system.

14. The first storage system of claim 13,
wherein the mode of operation switches from high workload mode to normal mode for the first storage system if the amount of first cache dirty data in the first cache area rises above the first threshold and then falls below a second threshold.

15. The first storage system of claim 13,
wherein the first cache area is provided by first storage devices in the first storage system and the second cache area is provided by second storage devices in the second storage system.

16. A method of I/O (input/output) in a system which includes a first storage system and a second storage system, the method comprising:
changing a mode of operation in the first storage system from a first mode to a second mode based on load of process in the first storage system;
wherein the load of process in the first storage system in the first mode is executed by the first storage system; and
wherein the load of process in the first storage system in the second mode is executed by the first storage system and the second storage system.

17. The method of claim 16,
wherein the first mode is normal mode and the second mode is high workload mode;
wherein the first storage system has a first cache area provided by first storage devices and a second cache area provided by second storage devices having higher performance than the first storage devices;
wherein during normal mode of operation, I/O (input/output) access to the first storage system is via the first cache area and not via the second cache area for each storage system; and
wherein the first storage system changes from the normal mode to the high workload mode if the first storage system has an amount of first cache dirty data in a first cache area which is higher than a first threshold, and the I/O access to the first storage system is through accessing a second cache area for the first storage system.

18. The method of claim 17, further comprising:
switching the mode of operation from high workload mode to normal mode for the first storage system if the amount of first cache dirty data in the first cache area rises above the first threshold and then falls below a second threshold.

19. The method of claim 16,
wherein the second storage system is an appliance having higher performance resources than resources in the first storage system;
wherein the first mode is normal mode and the second mode is high workload mode;
wherein during normal mode of operation, I/O (input/output) access to the first storage system is direct and not via the appliance; and
wherein the first storage system changes from the normal mode to the high workload mode if the first storage system has an amount of first cache dirty data in a first cache area which is higher than a first threshold, and the I/O access to the first storage system is through accessing the appliance during the high workload mode.

20. The method of claim 19,
wherein the mode of operation switches from high workload mode to normal mode if the amount of first cache dirty data in the first cache area rises above the first threshold and then falls below a second threshold.
